(19) United States
(12) Patent Application Publication
(10) Pub. No.: US 2012/0228157 A1
(43) Pub. Date: Sep. 13, 2012

(54) PROTECTION AND SURFACE MODIFICATION OF CARBON NANOSTRUCTURES

(75) Inventors: Chunhong Li, Chester Springs, PA (US); Piu Francis Man, Wilmington, DE (US); David J. Ruggieri, Plymouth Meeting, PA (US)

(73) Assignee: NanoSelect, Inc., Wilmington, DE (US)

(21) Appl. No.: 13/508,815

(22) PCT Filed: Nov. 11, 2010
(86) PCT No.: PCT/US10/56350

§ 371 Date: May 15, 2012

Related U.S. Application Data
(60) Provisional application No. 61/260,191, filed on Nov. 11, 2009.
(60) Provisional application No. 61/365,480, filed on Jul. 19, 2010.

(51) Int. Cl. C25B 11/06; C25B 11/02; H01B 1/04; G01N 27/26; B82Y 30/00; B82Y 40/00

(52) U.S. Cl. 205/780; 252/503; 205/775; 204/290.15; 204/290.01; 977/890; 977/847; 977/700; 977/957; 977/734

(57) ABSTRACT

Nanostructures comprising carbon and metal catalyst that are formed on a substrate, such as a silicon substrate, are contacted with a composition that, among other useful modifications, protects the nano structures and renders them stable in the presence of oxidizing agents in an aqueous environment. The protected nano structures are rendered stable over an extended period of time and thereby remain useful during such period as components of an electrode, for example, for detecting electrochemical species such as free chlorine, total chlorine, or both in water.

### CROSS REFERENCE TO RELATED APPLICATIONS

The present application claims the benefit of priority to U.S. Provisional App. No. 61/260,191, filed Nov. 11, 2009, and to U.S. Provisional App. No. 61/365,480, filed Jul. 19, 2010, both of which are incorporated herein in their respective entireties.

### TECHNICAL FIELD

The present disclosure relates to the protection and surface modification of nanostructures comprising carbon and metal catalysts formed on a substrate.

### BACKGROUND

Carbon nanotubes (CNTs) have remarkable mechanical and electronic properties. We have discovered that carbon nanotubes are especially useful as electrode-forming materials for electrochemical detection, such as free chlorine levels, total chlorine levels, or both in drinking water. See, for example, “CNT-Based Sensors: Devices, Processes and Uses Thereof”, by S. J. Pace, P. F. Man, A. P. Patil and K F. Tan, WO/2007/089550, published Aug. 9, 2007, by at least one of the inventors common with the instant specification. One important method for producing CNTs is to use small particles of a metal catalyst, such as nickel, cobalt and iron, that at high temperatures catalyze the decomposition of a carbon-containing gas, which in turn causes the “growth” of CNTs on each metal particle. Pursuant to such methods, a thin film of such catalyst may first be deposited on a silicon substrate with a titanium adhesion/barrier layer, followed by annealing at high temperature, which leads to the formation of small metal particles on the substrate. Then, when feed gases including acetylene, hydrogen and argon come into contact with the surface of each particle of metal catalyst, CNTs grow from the particles. Thereafter, the metal catalyst particles serve as conducting contacts between the CNTs and the substrate.

However, we have discovered that as-grown CNTs on a substrate, such as a silicon substrate are unstable due to the reactivity of catalyst particles as well as other nanostructures toward strongly oxidizing agents. As metal catalyst is oxidized and consumed, the electric contact between a CNT and the substrate is lost. As a result, CNTs fail to adhere to the substrate, and the ability to use the superior electronic properties of CNT for electrochemical detection is lost. Accordingly, there is a need to protect a variety of nano structures, such as metal catalyst particles and CNTs, from oxidation. These, and other problems are addressed by the inventions described herein.

### SUMMARY

In one aspect, provided are methods for the protection of a nanostructures comprising carbon and metal catalyst on a substrate comprising contacting the nanostructures with a composition comprising an alkyl protective moiety under conditions that permit the formation of an alkyl protective moiety layer disposed directly adjacent to at least a portion of the metal catalyst, the carbon, or both.

In another aspect, there are provided electrodes comprising nanostructures on a substrate, wherein the nanostructures comprise carbon and metal catalyst and have been protected by contacting the nanostructures with a composition comprising an alkyl protective moiety under conditions that permit the formation of an alkyl protective moiety layer directly adjacent to at least a portion of the metal catalyst, the carbon, or both.

In yet another aspect, there are disclosed methods for detecting electrochemical species in a fluid comprising applying a voltage between a working electrode and a reference electrode to produce a current between the working electrode and an auxiliary electrode, wherein said working electrode comprises nanostructures on a substrate, wherein the nanostructures comprise carbon, metal catalyst, and an alkyl protective moiety that forms an alkyl protective moiety layer disposed directly adjacent to at least a portion of the carbon, the metal catalyst, or both; a reference electrode, and wherein the current is proportional to the concentration of the electrochemical species in the fluid.

Also disclosed are methods for detecting electrochemical species in an aqueous fluid comprising a) forming a solution comprising said aqueous fluid and a reagent that reacts with the electrochemical species; b) contacting a working electrode, an auxiliary electrode, and a reference electrode with the solution, wherein the working electrode comprises nanostructures on a substrate, wherein the nanostructures comprise carbon, metal catalyst, and an alkyl protective moiety that forms an alkyl protective moiety layer directly adjacent to at least a portion of the carbon, the metal catalyst, or both; c) applying a voltage between the working electrode and the reference electrode, thereby generating a current between the working electrode and the auxiliary electrode; d) measuring the current; and, e) correlating the measured current to the amount of the electrochemical species in the aqueous fluid.

The present disclosure also provides methods for detecting electrochemical species in an aqueous fluid comprising a) forming a solution comprising said aqueous fluid and a reagent that reacts with the electrochemical species; b) contacting a working electrode and a reference electrode with the solution, wherein the working electrode comprises nanostructures on a substrate, wherein the nanostructures comprise carbon, metal catalyst, and an alkyl protective moiety that forms an alkyl protective moiety layer directly adjacent to at least a portion of the carbon, the metal catalyst, or both; c) applying a voltage between the working electrode and the reference electrode, thereby generating a current between the working electrode and the reference electrode; d) measuring the current; and, e) correlating the measured current to the amount of the electrochemical species in the aqueous fluid.

Also disclosed are methods for detecting electrochemical species in a fluid comprising: applying a voltage between a working electrode and a reference electrode to produce a current between said working electrode and a reference electrode, wherein said working electrode comprises nanostructures on a substrate, wherein said nanostructures comprise carbon, metal catalyst, and an alkyl protective moiety that forms an alkyl protective moiety layer disposed directly adjacent to at least a portion of said carbon, said metal catalyst, or both, and wherein said current is proportional to the concentration of said electrochemical species in said fluid.

Also provided are methods comprising detecting free chlorine, total chlorine, or both in a fluid using an electrode comprising nanostructures on a substrate, wherein the nanostructures comprise carbon, metal catalyst, and an alkyl protective moiety that forms an alkyl protective moiety layer directly adjacent to at least a portion of the carbon, the metal catalyst, or both.

In another aspect, disclosed are methods for modifying the surface hydrophobicity of nanostructures comprising carbon and metal catalyst on a substrate comprising contacting the nanostructures with a composition comprising an alkyl protective moiety under conditions that permit the formation of an alkyl protective moiety layer directly adjacent to at least a portion of the carbon, the metal catalyst, or both, whereby said contacted nanostructures are characterized as having increased wettability relative to the nanostructures prior to being contacted with the composition.

In yet another aspect there are disclosed electrodes comprising protected nanostructures disposed on a substrate, wherein the protected nanostructures comprise nanostructures comprising carbon and metal catalyst, the nanostructures further comprising an alkyl protective moiety layer disposed directly adjacent to at least a portion of the carbon, metal catalyst, or both, wherein the protected nanostructures are characterized as having increased wettability relative to the nano structures.

Also disclosed are protected nanostructures comprising nanostructures comprising carbon and metal catalyst, and further comprising an alkyl protective moiety layer disposed directly adjacent to at least a portion of the carbon, metal catalyst, or both, wherein the protected nanostructures are characterized as having increased wettability relative to the nano structures.

In yet another aspect there are provided methods for producing nanostructures that are substantially chemically inert comprising contacting nanostructures with a composition comprising an alkyl protective moiety under conditions that permit the formation of an alkyl protective layer directly adjacent to at least a portion of the nanostructures, wherein the layer is capable of minimizing nonspecific adsorption of electrochemical species on the nano structures.

Also disclosed are electrodes comprising protected nanostructures disposed on a substrate, wherein the protected nanostructures comprise nanostructures comprising carbon and metal catalyst, the nanostructures further comprising an alkyl protective moiety layer disposed directly adjacent to at least a portion of the carbon, metal catalyst, or both, wherein the protected nanostructures are characterized as having decreased nonspecific adsorption of electrochemical species relative to the nano structures.

In another aspect there are disclosed protected nanostructures comprising nanostructures comprising carbon and metal catalyst, and further comprising an alkyl protective moiety layer disposed directly adjacent to at least a portion of the carbon, metal catalyst, or both, wherein the protected nanostructures are characterized as having decreased nonspecific adsorption of electrochemical species relative to the nano structures.

In yet another aspect, there are provided electrodes comprising a conductive structure on a substrate, wherein the conductive structure comprises a conductive layer and an alkyl protective moiety disposed directly adjacent to at least a portion of the conductive layer, wherein said conductive structure is characterized as having one or more of decreased surface hydrophobicity, decreased background non-faradaic current, decreased nonspecific adsorption of electrochemical species, relative to the conductive layer.

Also disclosed are methods comprising contacting a conductive layer with a composition comprising an alkyl protective moiety under conditions that permit the formation of an alkyl protective moiety layer directly adjacent to at least a portion of the conductive layer, wherein the alkyl protective moiety layer is capable of minimizing the nonspecific adsorption of electrochemical species on the conductive layer.

### BRIEF DESCRIPTION OF THE DRAWINGS

The foregoing and other aspects of the present inventions will become apparent from the following detailed description when considered in conjunction with the accompanying drawings. For the purpose of illustrating the inventions, there is shown in the drawings embodiments that are presently preferred, it being understood, however, that the inventions are not limited to the specific aspects disclosed. The drawings are not necessarily drawn to scale. In the drawings:

FIG. 1 depicts the results of exposure of unprotected carbon nanotubes on a silicon substrate to 5% NaOCl aqueous solution, wherein dark squares and rectangles are patterned CNTs, dark circles are newly formed bubbles, and the light square marked by an arrow is an area of exposed substrate following the near-complete removal of CNTs.

FIG. 2 depicts how untreated CNTs can show poor wettability by water such that air bubbles become trapped at the location of the CNT patterns.

FIG. 3 shows an array of CNTs before (A) and after (B) contacting the CNTs with an alkyl protective moiety in accordance with the present disclosure.

FIG. 4 provides an illustration of how alkyphosphonic acids may function to protect a nickel catalyst particle on a silicon substrate.

FIG. 5 shows the response of an electrode comprising carbon nanotubes that has been protected with 1-octadecylphosphonic acid upon addition of free chlorine stock solution in 0.1M phosphate buffer (PBS, pH 5.5) with 0.01M KCl.

FIG. 6 shows the response of an electrode comprising carbon nanotubes that has been protected with 1-octadecanol upon serial addition of free chlorine stock solution in 0.1M PBS (pH 5.5) with 0.01M KCl.

FIG. 7 shows the response of an electrode comprising carbon nanotubes that has been protected with sodium dodecyl sulfate to free chlorine in 2.5 mM PBS (pH 7.3).

FIG. 8 shows the response of an electrode comprising carbon nanotubes that has been protected with tetradecyltrimethyl ammonium chloride to free chlorine in 2.5 mM PBS (pH 7.3).

FIG. 9 shows the response of an electrode comprising carbon nanotubes that has been protected with sodium dodecyl sulfate plus tetradecyltrimethylammonium chloride (SDS+TDTMACl, 1:1 molar ratio) upon addition of free chlorine in filtered tap water.

FIG. 10 shows the response of an electrode comprising carbon nanotubes that has been protected with n-octadecane followed by Brij®78 (C18EG20) to free chlorine in tap water saturated with CO₂ (pH 5.1).

FIG. 11 shows the response of an electrode comprising carbon nanotubes that has been protected with n-octadecane followed by Brij®78 hexadecyl ether (C18EG20C16) to free chlorine in tap water saturated with CO₂ (pH 5.1).

FIG. 12 shows the response of an electrode comprising carbon nanotubes that has been protected with n-octadecane followed by Brij®56 sulfate (C16EG10SO₃⁻) to free chlorine in tap water saturated with CO₂ (pH 5.1).

FIG. 13 shows the response of an electrode comprising carbon nanotubes that has been protected with n-octadecane followed by polyoxyethylene alkyl ether (III) to free chlorine in tap water saturated with CO₂ (pH 5.1).

FIG. 14 shows the response of an electrode comprising carbon nanotubes that has been protected with poly(maleic anhydride-alt-1-octadecene) upon addition of free chlorine in filtered tap water.

FIG. 15 shows the response of an electrode comprising carbon nanotubes that has been protected with n-octadecane followed by poly(oxyethylene) alkyl ether to free chlorine in filtered tap water over 7 days without the use of any additional reagent to adjust the sample pH and buffer capacity.

FIG. 16 shows the response of an electrode comprising carbon nanotubes that has been protected with n-octadecane followed by C16EG10SO₃⁻ to free chlorine in filtered tap water over 7 days without the use of any additional reagent to adjust the sample pH and buffer capacity.

FIG. 17 shows the response of an electrode comprising carbon nanotubes that has been protected with n-octadecane followed by C18EG20SO₃⁻ to NH₂Cl (0˜20 ppm) in filtered tap water saturated with CO₂ at 0.05V. The current at 10 seconds was recorded.

FIG. 18 shows the response of an electrode comprising carbon nanotubes that has been protected with n-octadecane followed by C12EG30 to NH₂Cl (0˜20 ppm) in tap water saturated with CO₂ at 0V. The current at 10 seconds was recorded.

FIG. 19 shows similar response of an electrode comprising carbon nanotubes that has been protected with n-octadecane followed by C18EG20C16 to both free chlorine and NH₂Cl (0˜10 ppm) in 2.5 mM H₃PO₄ at 0V.

FIG. 20 shows the response of an electrode comprising carbon nanotubes that has been protected with n-octadecane upon addition of free chlorine in the presence of N,N-diethyl-p-phenylenediamine (DPD) in filtered tap water over seven weeks.

FIG. 21 shows the response of an electrode comprising carbon nanotubes that has been protected with n-octadecane followed by n-dodecyl betaine to free chlorine with DPD in tap water.

FIG. 22 shows the response of an electrode comprising carbon nanotubes that has been protected with stearic acid upon addition of free chlorine in filtered tap water in the presence of 0.1 mM potassium iodide and 0.5 mM phosphoric acid.

FIG. 23 shows the response of an electrode comprising carbon nanotubes that has been protected with perfluorooctadecane to free chlorine in filtered tap water in the presence of 0.1 mM potassium iodide and 0.5 mM phosphoric acid.

FIG. 24 shows the response of an electrode comprising carbon nanotubes that has been protected with hexatriacontane followed by dioctylamine to free chlorine in filtered tap water in the presence of 0.1 mM potassium iodide and 0.5 mM phosphoric acid.

FIG. 25 shows the response of an electrode comprising carbon nanotubes that has been protected with sodium 1-dodecanesulfonate to free chlorine in filtered tap water in the presence of 0.1 mM potassium iodide and 0.5 mM phosphoric acid.

FIG. 26 shows the response of an electrode comprising carbon nanotubes that has been protected with n-octadecane followed by poly(oxyethylene) alkyl ether to total chlorine in the presence of KI in filtered tap water over seven weeks.

FIG. 27 shows the response to free chlorine in the presence of DPD in tap water of both a screen-printing electrode and same electrode protected with an alkyl protective moiety in accordance with the present disclosure.

FIG. 28 shows the response to free chlorine in CO₂-saturated filtered tap water of a diamond electrode protected according to the present disclosure with C18EG20C16 over n-C₁₈H₃₈ in accordance with the present disclosure during a period of two weeks.

FIG. 29 shows the response to free chlorine in CO₂-saturated filtered tap water of a diamond electrode without protection over three weeks.

### DETAILED DESCRIPTION OF ILLUSTRATIVE EMBODIMENTS

The present inventions may be understood more readily by reference to the following detailed description taken in connection with the accompanying figures and examples, which form a part of this disclosure. It is to be understood that these inventions are not limited to the specific products, methods, conditions or parameters described and/or shown herein, and that the terminology used herein is for the purpose of describing particular embodiments by way of example only and is not intended to be limiting of the claimed inventions.

In the present disclosure the singular forms “a,” “an,” and “the” include the plural reference, and reference to a particular numerical value includes at least that particular value, unless the context clearly indicates otherwise. Thus, for example, a reference to “a nano structure” is a reference to one or more of such structures and equivalents thereof known to those skilled in the art, and so forth. When values are expressed as approximations, by use of the antecedent “about,” it will be understood that the particular value forms another embodiment. As used herein, “about X” (where X is a numerical value) preferably refers to ±10% of the recited value, inclusive. For example, the phrase “about 8” preferably refers to a value of 7.2 to 8.8, inclusive; as another example, the phrase “about 8%” preferably (but not always) refers to a value of 7.2% to 8.8%, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

Unless otherwise specified, any component, element, attribute, or step that is disclosed with respect to one aspect of the present invention (for example, methods, electrodes, and nanostructures, respectively) may apply to any other aspect of the present invention (any other of the methods, electrodes, and nanostructures, respectively) that is disclosed herein. For example, an alkyl protective moiety that is disclosed with respect to the present methods for the protection of nanostructures may be used in connection with any other of the disclosed methods, any of the electrodes or nanostructures disclosed herein, or any other presently disclosed embodiment.

Nanotechnology has become an object of growing interest among materials scientists, electrical engineers, chemists, biologists, and scientific practitioners in a wide variety of other fields. Nano structures, including carbon nanotubes, are of potential utility in practical applications ranging from medicine to engineering. However, nanotechnology is a relatively new subject of inquiry and there remain numerous barriers to the use of nano-scale structures in certain contexts. Nano structures constitute unique arrangements of atoms and undergo different physical and chemical interactions with other molecules as compared with physically larger structures, and as such their behaviors in relation to other molecules are not readily predicted.

Carbon nanotubes (“CNTs”) are among the strongest and stiffest materials known to science, in terms of tensile strength and elastic modulus respectively, but they are subject to oxidation reactions. It is believed that these oxidation reactions arise from the existence of covalent sp² bonds between the individual carbon atoms in CNTs; such bonds, when not part of aromatic conjugation system, are vulnerable to oxidizing agents. Likewise, as with any materials, structural defects in CNTs certainly exist. Such defects are especially prone to oxidative damage. The electronic properties of CNTs are severely affected by structural damages in CNTs. Accordingly, there is a need to protect both the nickel particles and CNTs from oxidation to preserve the structural and electronic integrity of the CNTs on substrates.

CNT surfaces are also highly hydrophobic. This hydrophobicity presents a wetting problem when CNTs are used as electrode material. When used in aqueous medium, untreated CNT surfaces may behave as non-conducting or resistive due to the lack of contact with electrolyte solution. The as-grown CNT patterns readily trap air bubbles that render the surfaces of individual CNTs inaccessible to the electrolytic aqueous solution. As a result, it is extremely difficult to control the effective electrode surface area for electrochemical detection. The resulting low current response makes it impossible to calibrate and quantify analyte concentration in aqueous solution. Thus, for the CNTs to remain conductive in aqueous medium, it is necessary to control their surface hydrophobicity.

The unique physical and chemical properties of nano structures and of the specific combination of nanoarrayed carbon and metal catalyst on a substrate, have made the solution to the above-described problems elusive. Aspects of the present inventions provided herein provide effective means for simultaneously protecting CNTs and the metal catalyst particles from which they grow from oxidation, controlling the surface hydrophobicity of the CNTs, while retaining the sensitivity of the CNTs to electrical changes in the ambient environment and the ability of the CNTs to transmit electrical information to a substrate.

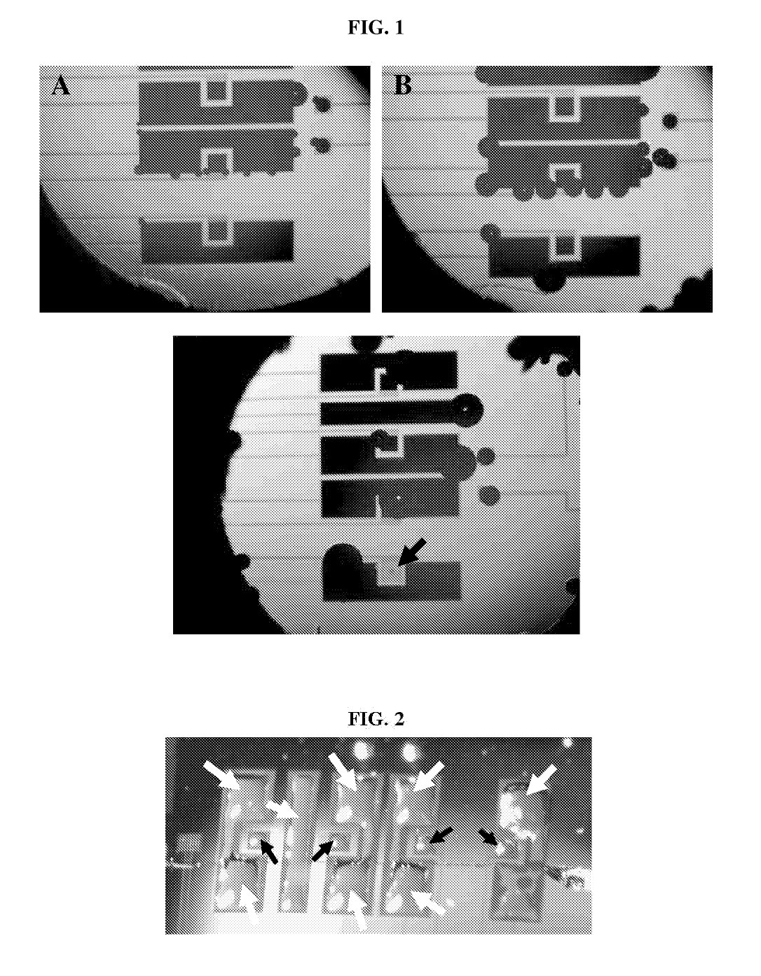

Nanostructures can be grown on substrates for use in electronics, but various conditions can reduce the efficacy as electrical components. As discussed above, oxidation of metal catalyst particle such as nickel that conjoin a carbon nanotube or other carbon-based nanostructure with a substrate can weaken or destroy the electrical conductivity between the substrate and the nanostructure. For example, as shown in FIG. 1A and FIG. 1B, when CNTs that have been grown on a silicon chip are treated with 5% NaOCl solution, bubble formation (seen as dark circles) is observed along the edge of the CNT patterns (dark squares and rectangles). The oxidation of nickel particles may be so severe that the CNTs are severed from the substrate, revealing the underlying substrate (see FIG. 1C, seen as a light-colored square, marked by arrow). FIG. 2 depicts how untreated CNTs that have been grown on a silicon substrate and immersed in aqueous solution can show poor wettability by water such that air bubbles (marked by black and white arrows) become trapped at the location of the CNT patterns.

However, the present inventors have found a unique solution to the problem of the instability of nanostructures, catalyst particles for nanostructures, and nanostructure arrays in aqueous environments. It has presently been discovered that treatment of metal particles that can be used as catalysts for the growth of carbon nano structure, such as carbon nanotubes, with an alkyl protective moiety can be used to protect such particles from a number of conditions that are present in aqueous environments. For example, contacting a nickel particle with an alkyl phosphonic acid, an alkyl phosphonate, an alkane, an alkanol, an alkyl carboxylic acid, and alkyl carboxylate, a polyoxyethylene alkyl ether, or any combination thereof can be used to protect such a particle from the otherwise corrosive effects of oxidation. It has also been found that exposure to the same compositions can protect nanostructures that are grown from the catalyst particles from the non-specific adsorption of environmental materials over time, even while such nanostructures remain capable of conducting electrons from the ambient environment to the substrate onto which the particle and nanostructure are affixed. It has likewise been discovered that exposure of nanostructures to the same compositions can serve to increase the wettability of the protected nanostructures relative to the nanostructures in the unprotected state. Furthermore, it is been found that the nanostructures may be protected such that the effective electrode surface area for electrochemical detection is substantially equal to the effective electrode surface area of the nanostructures relative to the nanostructures in the unprotected state. Thus, it has surprisingly been found that contacting an electrode comprising a metal particle and a nanostructure that is attached to such particle with an alkyl protective moiety protects the metal particle from oxidation, even while the nanostructure remains capable of conducting electrons and can possess other characteristics that render the nanostructures more useful for various electronic applications.

Therefore, as contrasted with prior methodologies for protecting structures from oxidation, the present disclosure provides protection against oxidation and the non-specific adsorption of other environmental materials that can cause deterioration or a change in the physical behavior of the structure without compromising the sensitivity of a nanostructure to the presence of electrons. Prior methodologies included treatment with SiO₂, which although relatively efficacious in protecting against oxidation, resulted in the reduction of the sensitivity of the treated structure to ambient electrons. Specifically, in accordance with such methods, the as-grown carbon nanotube nanoelectrode arrays are first encapsulated with dielectric SiO₂, followed by a chemical mechanical polishing step to remove SiO₂ from the top and to expose carbon nanotube arrays. After polishing, the nanoelectrodes had to be electrochemically etched to improve their electrochemical activity for analysis. No such drawbacks result from the techniques according to the present disclosure, which provides effective protection of nanostructures, nickel particles that conjoin a carbon nanotube or other carbon-based nanostructure to a substrate, or catalyst particles from which nanostructures are grown while preserving the sensitivity of such nanostructures to the electrical conditions to the ambient environment into which they are placed.

Methods described herein protect nanostructures comprising carbon and metal catalyst on a substrate. The disclosed methods comprise contacting said nanostructures with a composition comprising an alkyl protective moiety under conditions that permit the formation of an alkyl protective layer disposed directly adjacent to at least a portion of said metal catalyst, said carbon, or both.

Numerous types of nanostructures are known in the art and may include Buckminsterfullerenes, nanowires, nanorods, nanotubes, branched nanowires, nanotetrapods, nanotripods, nanohorns, nanobipods, nanocrystals, nanodots, quantum dots, nanoparticles, nanoribbons, 2D-3D graphene structures or any combination thereof. In a preferred embodiment, the nanostructures are carbon nanotubes. Carbon nanotubes include single wall and multi-wall carbon nanotubes.

Metal catalysts suitably include but are not limited to iron, nickel, and cobalt. Metal catalysts can be deposited on substrates using a variety of methods known in the art. Nonlimiting examples of catalyst deposition include sputtering, evaporation, and dip coating.

Substrates include but are not limited to silicon, polysilicon (e.g., doped polysilicon), titanium, and chromium. The substrate may be a conductive layer or a diffusion layer. Screen-printing carbon electrodes, which may comprise single-wall or multi-wall carbon nanotubes on a substrate (such as ceramic), may also be protected in accordance with the present disclosure.

The alkyl protective layer may have a thickness in the range of from about 1 nm to about 500 nm; about 10 nm to about 300 nm; about 50 nm to about 250 nm; or, about 50 nm to about 100 nm.

The alkyl protective moiety may comprise a compound having the formula (I):

R₁(CH₂)ₙR₂X (I)

in which:

R₁ represents hydrogen, or a C₁₋₅₀ straight or branched alkyl or alkenyl, which is optionally substituted with one or more halogen atoms;

R₂ represents a single bond, an aromatic or alicyclic group, —(OCH₂CH₂)ₘ—, —(OCH₂CH₂CH₂)ₘ—, or —[OCH₂CH(CH₃)]ₘ—, wherein m and n are each independently 0 to 500;

X is hydrogen, halogen, —N₃, —CN, —OH, —OSO₃⁻, —OR, —SH, —SR, —S—S—R, —SO₃H, —SO₃R, —SO₃⁻, —PO₃H₂, —PO₃H⁻, —(PO₃)²⁻, —P(═O)(—OR′)(OR″), —OPO₃H₂, —OPO₃H⁻, —O(PO₃)²⁻, —COOH, —COO⁻, —COOR, —CONR′R″, —NH₂, —NR′R″, —N(COR′)R″, —N⁺R′R″R′″, —N⁺C₅H₅, —(OCH₂CH₂)ₘ—OR, —(OCH₂CH₂CH₂)ₘ—OR, —[OCH₂CH(CH₃)]ₘ—OR, a polyol, or a monosaccharide or a polyethylene oxide derivative thereof;

R may be R₁, R₁(CH₂)ₙR₂ or —(CH₂)ₙR₂X; and,

R′, R″, R′″ are each independently hydrogen, alkyl, cycloalkyl, alkyl and cycloalkyl substituted by one or more hydroxyl groups, alkyl and cycloalkyl substituted by one or more carboxylic groups, —(CH₂CH₂O)ₙR, —(CH₂CH₂CH₂O)ₙR, or —[CH₂CH(CH₃)O]ₙR.

Any polyol may be selected for use as the X substituent in a compound of the formula (I). Polyols are readily recognized among those skilled in the art as compounds having multiple hydroxyl functional groups. For example, polyols may be diols, triols, tetrols, pentols, and the like. Nonlimiting examples of polyols include polyethylene glycol, pentaerythritol, ethylene glycol, glycerin pentaerythrityl, polyglycerol, sorbitan, polyethylene oxide derivatives of sorbitan, sugar alcohols, trimethylolethane, and trimethylolpropane. Other examples of polyols will be readily appreciated by those skilled in the art.

The alkyl protective moiety may comprise an alkyl phosphonic acid, an alkyl phosphonate, an alkane, an alkanol, an alkyl carboxylic acid, an alkyl carboxylate, a polyoxyethylene alkyl ether, or any combination thereof.

Suitable alkyl phosphonic acids include, for example, n-octylphosphonic acid, n-decylphosphonic acid, n-octadecylphosphonic acid, or a salt or an ester thereof, or any mixture thereof.

Exemplary alkanes include n-octadecane, perfluorooctadecane, n-dodecane and hexatriacontane.

Exemplary alkanols include n-octadecanol, n-dodecanol, and the like.

Exemplary alkyl carboxylic acids include n-octadecanoic acid, n-dodecanoic acid, p-decylbenzoic acid and the like.

Alkyl amines are also suitable alkyl protective moieties. Examples include dioctadecylamine, didodecylamine and the like.

Alkyl amides can also be used as alkyl protective moieties. For example, dioctadecylamine can be converted to amides with various acids such as acetic acid, trimethylacetic acid, cyclopentanecarboxylic acid, cholic acid and the like.

Still other suitable alkyl protective moieties include quaternary amines. Examples include tetradecyltrimethylammonium chloride and n-dodecyl betaine and the like.

Exemplary polyoxyethylene alkyl ethers include tetraethyleneglycol monooctyl ether (designated as C8EG4), hexaethyleneglycol monododecyl ether (C12EG6), heptaethyleneglycol monohexadecyl ether (C16EG7) and commercially available detergents, identified by the trade names Brij®30 (C12EG4), Brij®52 (C16EG2), or Brij®56 (C16EG10), Brij®58 (C16EG20), Brij®35 (C12EG30), Brij®78 (C18EG20) (Croda International PLC, East Yorkshire, England).

The free hydroxyl group in these polyoxyethylene alkyl ethers can be further modified with C₁₋₂₀ straight or branched alkyl or alkenyl, which is optionally substituted by one or more halogen atoms. For instance, heptaethyleneglycol dihexadecyl ether (C16EG7C16), Brij®56 methyl ether (C16EG10Me), Brij®56 hexyl ether (C16EG10C6), Brij®78 hexadecyl ether (C18EG20C16) can be used as alkyl protective moiety on CNT electrode.

The free hydroxyl group in these polyoxyethylene alkyl ethers can also be further modified with negative charge when treated with SO₃ trimethylamine complex or P₂O₅. Brij®56 sulfate (C16EG10SO₃⁻), Brij®30 sulfate (C12EG4SO₃⁻), Brij®78 sulfate (C18EG20SO₃⁻), Brij®35 sulfate (C12EG30SO₃⁻), Brij®78 phosphate (C18EG20PO₃H₂) can also be used as alkyl protective moiety on CNT electrode.

In other embodiments, the alkyl protective moiety may comprise a compound of formula (II), formula (III), or both:

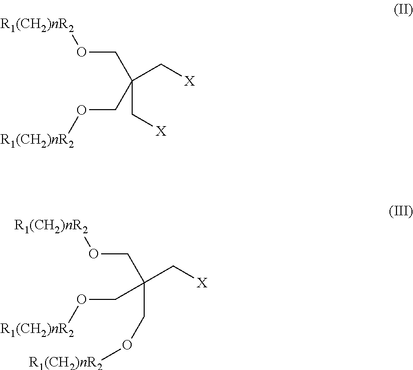

in which:

R₁ is hydrogen, or a C₁₋₅₀ straight or branched alkyl or alkenyl, optionally substituted with one or more halogen atoms

R₂ represents a single bond, an aromatic or alicyclic group, —(OCH₂CH₂)ₘ—, —(OCH₂CH₂CH₂)ₘ—, or —[OCH₂CH(CH₃)]ₘ—, wherein m and n are each independently 0 to 500;

X is hydrogen, halogen, —N₃, —CN, —OH, —OSO₃⁻, —OR, —SH, —SR, —S—S—R, —SO₃H, —SO₃R, —SO₃⁻, —PO₃H₂, —PO₃H⁻, —(PO₃)²⁻, —P(═O)(—OR′)(OR″), —OPO₃H₂, —OPO₃H⁻, —O(PO₃)²⁻, —COOH, —COO⁻, —COOR, —CONR′R″, —NH₂, —NR′R″, —N(COR′)R″, —N⁺R′R″R′″, —N⁺C₅H₅, —(OCH₂CH₂)ₘ—OR, —(OCH₂CH₂CH₂)ₘ—OR, —[OCH₂CH(CH₃)]ₘ—OR, a polyol, or a monosaccharide or a polyethylene oxide derivative thereof;

R is be R₁, R₁(CH₂)ₙR₂ or —(CH₂)ₙR₂X; and,

R′, R″, R′″ are each independently hydrogen, alkyl, cycloalkyl, alkyl and cycloalkyl substituted by one or more hydroxyl groups, alkyl and cycloalkyl substituted by one or more carboxylic groups, —(CH₂CH₂O)ₙR, —(CH₂CH₂CH₂O)ₙR, or —[CH₂CH(CH₃)O]ₙR.

Any polyol may be selected for use as the X substituent in a compound of the formula (III). Polyols are readily recognized among those skilled in the art as compounds having multiple hydroxyl functional groups. For example, polyols may be diols, triols, tetrols, pentols, and the like. Nonlimiting examples of polyols include polyethylene glycol, pentaerythritol, ethylene glycol, glycerin pentaerythrityl, polyglycerol, sorbitan, polyethylene oxide derivatives of sorbitan, sugar alcohols, trimethylolethane, and trimethylolpropane. Other examples of polyols will be readily appreciated by those skilled in the art.

In other embodiments, the alkyl protective moiety is a homo- or copolymer of the general formula (IV):

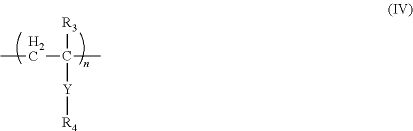

wherein

R₃ and R₄ are each independently hydrogen, halogen, cyano, a maleic anhydride group, phenyl, or a C₁₋₅₀ straight or branched alkyl optionally substituted with one or more halogen atoms;

Y represents a single bond, —O—, —CO—, —CO—O—, —O—CO—, —CONR′—, —O—CO—NR′—, or —NR′—CO—, wherein R′ represents a hydrogen or alkyl group, and n is 10 to 500.

The alkyl protective moiety may also be a polymer of the formula (V):

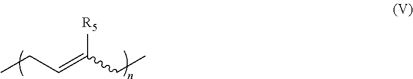

wherein

R₅ is hydrogen, halogen, or a C₁₋₅₀ straight or branched alkyl optionally substituted with one or more halogen atoms, and

n is 10 to 500.

In still other embodiments, the alkyl protective moiety may be a polymer of the formula (VI):

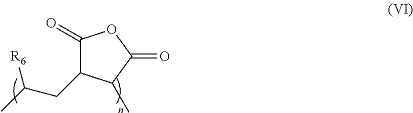

wherein

R₆ is a C₁₋₅₀ straight or branched alkyl optionally substituted with one or more halogen atoms, and

n is 10 to 500.

An exemplary alkyl protective moiety according to formula (VI) is poly(maleic anhydride-alt-1-octadecene).

In other embodiments, the alkyl protective moiety comprises an alkyl phosphonic acid, an alkyl phosphonate, an alkane, an alkanol, an alkyl carboxylic acid, and alkyl carboxylate, a polyoxyethylene alkyl ether, alkyl amine, alkyl sulfate, alkanethiol, alkyl sulfonate, alkyl quaternary ammonium salt, alkyl betaine, polyoxyethylene alkyl ether sulfate, poly(maleic anhydride-alt-1-octadecene), perfluoro-alkane, or any combination thereof.

In yet other embodiments, the alkyl protective moiety may comprise a polyoxyethylene alkyl ether having the formula (VII):

R—(OCH₂CH₂)ₙ—OR₁ (VII)

wherein

R is an optionally substituted, linear or branched, saturated, carbo- or heteroalkyl chain bearing 4 to 18 carbon atoms,

n is 1 to 30, and

R₁ is hydrogen, R, —SO₃⁻, or —PO₃².

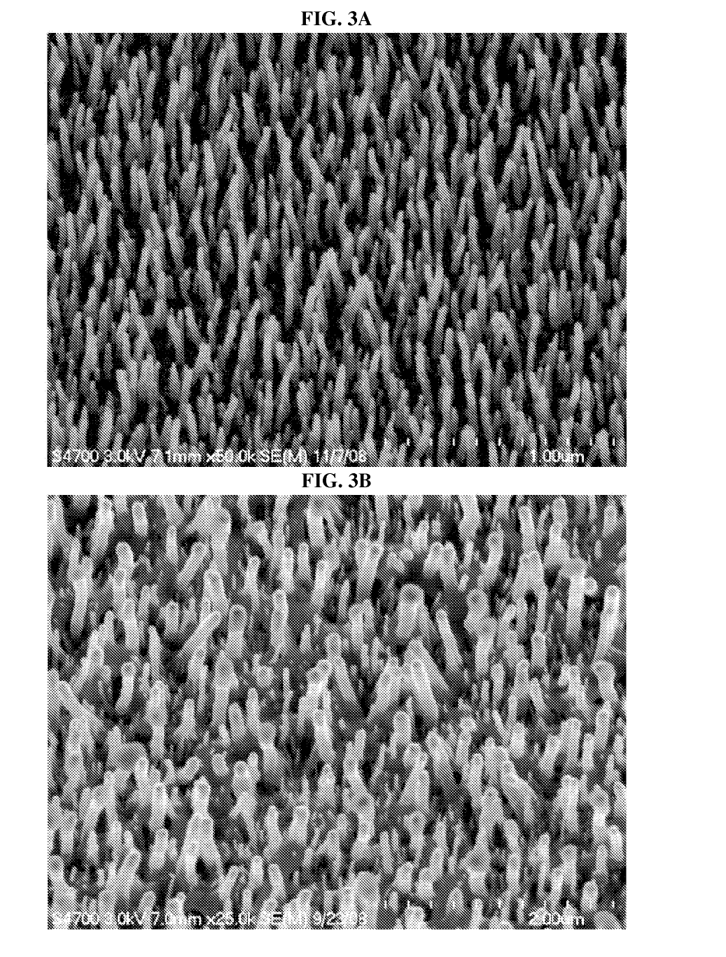

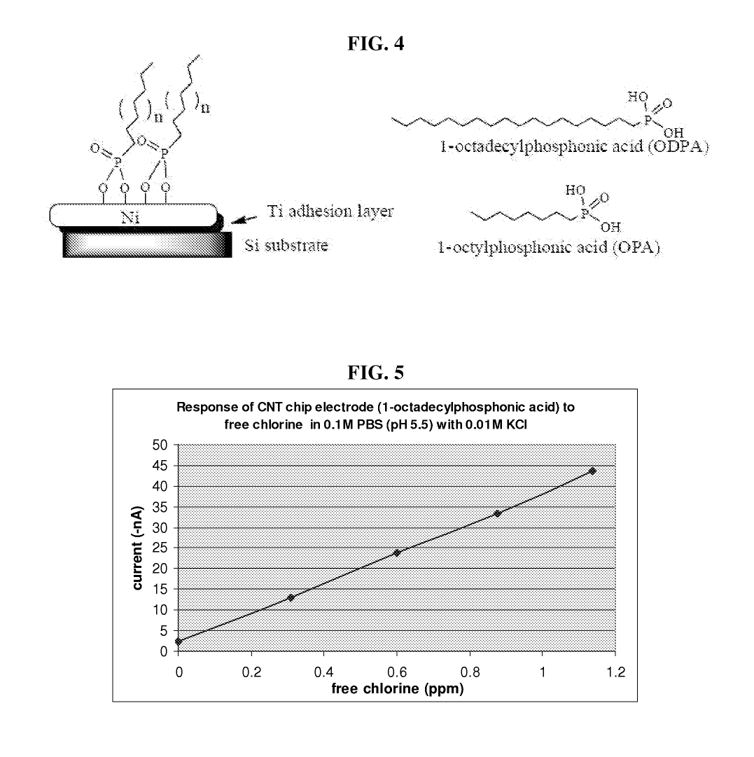

Without intending to be bound by any particular theory of operation, it is believed that the alkyl chains in the alkyl protective moieties according to the present disclosure, can interact with the surfaces of nanostructures by wrapping around the surfaces of individual nanostructures to ensure a layer for long-term stability. It is believed that a layer of alkyl protective moiety (having a thickness of, for example, about 1 nm to about 500 nm) will shield the underlying sp² bonds in nanostructures, such as carbon nanotubes, from direct exposure to oxidizing agents in testing media. In terms of reactivity, alkyl protective moieties are mostly made of sp³ C—C and C—H bonds, which are much less prone to oxidation than C═C bonds. By protecting the surfaces of nanostructures with alkyl protective moieties, it is believed that the hydrophobicity of the surfaces of nanostructures, thus the wettability of the nanostructures is thereby modulated and controlled. FIG. 3 shows an array of CNTs before (A) and after (B) contacting the CNTs with an alkyl protective moiety in accordance with the present disclosure. FIG. 4 is an illustration of how alkyphosphonic acids may function to protect a nickel particle on a silicon substrate. It has also been discovered herein that phosphonic acid group is not required for the protection of metal particles as alkanes, alkanols, alkyl carboxylic acids, alkyl carboxylates, polyoxyethylene alkyl ethers, and other alkyl protective moieties that lack the phosphonic acid group can also adequately protect nickel particles and carbon nanotube electrodes from oxidative damages.

The composition comprising an alkyl protective moiety may further comprise a solvent. In preferred embodiments, the solvent dissolves the alkyl protective moiety but not the nanostructures or substrate. The solvent may be one or more of tetrahydrofuran (THF), isopropyl alcohol, ethyl acetate, hexanes, acetone, methylene chloride, chloroform, N,N-dimethyl formamide (DMF), dimethylsulfoxide, and supercritical CO₂. Any of a variety of solvents may be used that are capable of maintaining the alkyl protective moiety in solution. The composition comprising the alkyl protective moiety and a solvent may comprise from about 0.1 mM to about 100 mM alkyl protective moiety in solvent.

Any of the alkyl protective moieties and compositions comprising an alkyl protective moiety that have been described herein in connection with the disclosed methods for the protection of nanostructures may also be used in connection with any of the other methods that are described in the present disclosure, including the methods for detecting electrochemical species in a fluid, methods for detecting electrochemical species in an aqueous fluid, methods for detecting free chlorine, total chlorine or both, methods for modifying the surface hydrophobicity of nanostructures, methods for producing nanostructures that are substantially chemically inert, and methods wherein the alkyl protective moiety is capable of minimizing nonspecific adsorption of electrochemical species, as well as the presently described electrodes and protected nano structures. Thus, where a certain embodiment refers to the use or inclusion of an alkyl protective moiety or a composition comprising an alkyl protective moiety, then any of the alkyl protective moieties that have been described in the present disclosure may be used in connection with that embodiment, even when that particular alkyl protective moiety or composition comprising an alkyl protective moiety has only been described in connection with a different embodiment.

Contacting the nanostructures with the described composition under conditions that permit the formation of a protective layer may include partial or complete immersion of the substrate on which the nanostructures are present into a bath of the composition. The substrate may be removed from the composition after a desired period of time, for example, after about 30 minutes to about six hours, after about one to about 3.5 hours, or after about three hours. Alternatively, the substrate may remain in a bath of the composition until a substantial amount of the composition has evaporated and all or part of the substrate is exposed to the ambient environment. Evaporation of a sufficient quantity of the composition may occur after about one to about six hours, after about two to about 3.5 hours, or after about three hours. Shorter and longer times are possible as well, which will also depend somewhat on temperature and concentration of the composition and the nano structures.

In other embodiments, contacting the nanostructures with the composition may include vapor exposure of the nanostructures to the composition, under atmospheric pressure or vacuum, for example, by spraying the substrate with the composition. The contact time required for vapor exposure of the nanostructures to the composition may be as brief as a minute or more, such as for about one minute to about 10 minutes of exposure, from about 2 minutes to about 6 minutes of exposure, or from about 3 minutes to about 5 minutes of exposure. Preferably, the contacting of the nanostructures with the composition via vapor exposure occurs under vacuum, at temperatures that are elevated above the ambient (e.g., from about 30° C. to about 200° C., from about 50° C. to about 150° C., or from about 80° C. to about 120° C.), or both.

In other embodiments, the composition may be spin-coated onto the substrate in order to contact the nanostructures with the composition. Spin coating may be performed in accordance with appropriate procedures known among those skilled in the art. For example, a composition solution is coated on a nanostructure by use of a syringe or pipette, after which the nanostructure is spun at a low to moderate speed 500-1000 rpm for 5-10 seconds to evenly spread the solution. The thickness of the coating is then determined and controlled during a second stage by spinning the coating at a higher speed, between 1500-3000 rpm for anywhere between a few seconds and a minute. The solvent is then allowed to evaporate to afford a smooth coating on the nanostructure.

The composition may also be drop-cast onto the substrate in order to contact the nanostructures with the composition. Drop-casting of the composition onto the substrate may be performed in accordance with appropriate procedures known among those skilled in the art. For example, a specific volume of a composition solution is first dropped onto a nanostructure by use of a syringe or pipette to ensure complete coverage of the nano structure. The solvent is then allowed to evaporate in air or an inert environment to achieve direct contact between the composition and the nanostructure.

After contacting the nanostructures with the composition, the substrate and nanostructures may be exposed to an environment consisting essentially of one or more inert gasses, such as Ar or N₂ or combination thereof. The formation of a protective layer may also include heating the substrate and nanostructures after contacting the nanostructures with the composition. Heating is performed at a temperature and for a time that is sufficient to allow the alkyl protective moiety to become disposed directly adjacent to the surface of at least a portion of the metal catalyst, the carbon, or both. For example, heating may occur at about 100° C. to about 200° C., at about 120° C. to about 160° C., at about 130° C. to about 150° C., or at about 140° C. The duration of the heating may be from about 6 hours to about 4 days, about 12 hours to about 3 days, about 24 hours to about 2 days, or about 2 days. Following heating, the substrate and nanostructures may be cooled to about room temperature (for example, may be allowed to equilibrate to room temperature, about 60° C. to about 75° C.), and then contacted with a polar solvent, such as THF. For example, the contacting of the substrate and nanostructures may comprise immersing the substrate in THF for about 15 minutes to about 1 hour, preferably for about 30 minutes. The substrate may then be removed from the polar solvent, for example, the polar solvent may be allowed to evaporate. At this point, the substrate may be ready for wire-bonding.

In another embodiment, after contacting the nanostructures with a first composition [e.g., n-octadecane (OD) in THF], heating at a specific temperature for a period of time, and rinsing with a solvent, the substrate may be contacted with a second composition (e.g., polyoxyethylene alkyl ether in THF), then subjected to heating and rinsing with a solvent. Afterwards, the substrate may be ready for wire-bonding. In this example, the nanostructures will be protected with polyoxyethylene alkyl ether over n-octadecane.

In some embodiments, after the substrate is removed from the polar solvent, it may be contacted with a further solvent, such as dimethylformamine (DMF). The substrate may be partially or completely immersed in the further solvent, and the immersed substrate may be heated and then allowed to cool to ambient temperatures. For example, heating may occur at about 35° C. to about 50° C., preferably from about 40° C. to about 45° C. for a duration of about 6 hours to about 24 hours, preferably for about 12 to about 20 hours, after which time the substrate and solvent may be allowed to equilibrate to room temperature. Following exposure to the further solvent, the substrate and nanostructures may be contacted with methanol (e.g., may be rinsed with methanol) and permitted to dry. The substrate will then be ready for wire-bonding.

In some embodiments, the nanostructures are contacted with the composition under conditions that increase the wettability of the nano structures, i.e., relative to the wettability of the nanostructures before they had been contacted with the composition. As provided above, FIG. 2 depicts how untreated CNTs that have been grown on a silicon substrate and immersed in aqueous solution can show poor wettability by water such that air bubbles (marked by black and white arrows) become trapped at the location of the CNT patterns. When CNTs that had been grown on a silicon substrate were protected with an alkyl protective moiety in accordance with the present disclosure, no trapped air bubbles were observed (not shown), indicating that the protection of the CNTs increased the wettability of the CNT arrays. In accordance with another aspect of the present disclosure, there are provided protected nanostructures comprising nanostructures comprising carbon and metal catalyst, and further comprising an alkyl protective moiety layer disposed directly adjacent to at least a portion of the carbon, metal catalyst, or both, wherein the protected nanostructures are characterized as having increased wettability relative to the nanostructures

Also disclosed are electrodes comprising nanostructures on a substrate, wherein the nanostructures comprise carbon and metal catalyst on a substrate and have been protected in accordance with the presently disclosed methods. Any electrode comprising nanostructures on a substrate may be protected in accordance with all of the inventions disclosed herein. For example, screen-printing carbon electrodes, which may comprise single-wall or multi-wall carbon nanotubes on a substrate (such as ceramic), may be protected in accordance with the present disclosure. Such electrodes may be used, for example, to detect free chlorine, total chlorine, or both in a solution. The protected nanostructures are more stable than if unprotected, and are more stable than permitted by use of previous methods. As a result, the protection of the nano structure in accordance with the present disclosure endows the electrodes of the present disclosure with long term functionality. At the same time, sensitivity of the present electrodes remains high, as the protection of the nanostructures according to the instant invention does not cause an increase in background current. In other aspects, disclosed are nanostructures comprising carbon and metal catalyst that have been protected in accordance with presently disclosed methods.

In another aspect, disclosed are electrodes comprising protected nanostructures disposed on a substrate, wherein the protected nanostructures comprise nanostructures comprising carbon and metal catalyst, the nanostructures further comprising an alkyl protective moiety layer disposed directly adjacent to at least a portion of said carbon, metal catalyst, or both, wherein the protected nanostructures are characterized as having increased wettability relative to the nano structures. Also provided herein are protected nanostructures comprising nanostructures comprising carbon and metal catalyst, the nanostructures further comprising an alkyl protective moiety layer disposed directly adjacent to at least a portion of said carbon, metal catalyst, or both, wherein the protected nanostructures are characterized as having increased wettability relative to the nano structures.

In yet another aspect, disclosed are methods for detecting electrochemical species in a fluid comprising applying a voltage between a working electrode and a reference electrode to produce a current between the working electrode and an auxiliary electrode, wherein said working electrode comprises nanostructures on a substrate, wherein the nanostructures comprise carbon, metal catalyst, and an alkyl protective moiety that forms an alkyl protective moiety layer disposed directly adjacent to at least a portion of the carbon, the metal catalyst, or both; a reference electrode, and wherein the current is proportional to the concentration of the electrochemical species in the fluid.

The electrochemical species may be, for example, free chlorine, total chlorine, or both. The fluid in which the electrochemical species are detected may be aqueous, and may comprise water, such as drinking water. The detection of electrochemical species in accordance with the present disclosure benefits from the long term stability and sensitivity of the protected nanostructures, and thus represents a superior means for detecting electrochemical species accurately and over a long period of time.

Detection of electrochemical species using electrodes is performed in accordance with techniques that are familiar to those of ordinary skill in the art. With regard to the present disclosure, reagentless free chlorine analysis may be performed as follows. A water sample solution such as drinking tap water is first exposed to the working electrode, an auxiliary electrode and the reference electrode. A predetermined voltage between the working electrode and the reference electrode is then applied for a specified period (e.g., about 10 seconds), whereby a current is generated between the working electrode and the auxiliary electrode. The free chlorine in the sample is correlated to the measured current. As drinking tap water has limited buffer capacity and variable pH from day to day, response to free chlorine becomes non-linear above 2 ppm.

Alternatively, reagentless free chlorine analysis may be performed in a buffered solution (e.g., CO₂ saturated tap water or sodium phosphate buffered tap water solution) in order to maintain the desired solution pH. Under this condition, linear response to free chlorine could be obtained at, for example, 10 ppm or higher.

Reagentless NH₂Cl analysis may also be performed in drinking tap water or tap water saturated with CO₂ or buffered with phosphate. A stable response could be obtained up to 20 ppm of NH₂Cl (free chlorine equivalent) using similar techniques as that for free chlorine.

Also disclosed are methods for detecting free chlorine, total chlorine, or both in an aqueous fluid comprising a) forming a solution comprising said aqueous fluid and a reagent that can be oxidized by free chlorine or total chlorine; b) contacting a working electrode, an auxiliary electrode, and a reference electrode with the buffered solution, wherein said working electrode comprises nanostructures on a substrate, wherein said nanostructures comprise carbon, metal catalyst, and an alkyl protective moiety that forms an alkyl protective moiety layer directly adjacent to at least a portion of said carbon, said metal catalyst, or both; c) applying a voltage between the working electrode and the reference electrode, thereby generating a current between the working electrode and the auxiliary electrode; d) measuring the current; and, e) correlating said measured current to the amount of free chlorine, total chlorine, or both in said aqueous fluid.

The aqueous fluid may comprise sodium phosphate to maintain the optimal pH for the reaction between free (and/or total) chlorine and the reagents. The reagent may comprise potassium iodide, a salt of N,N-diethyl-p-phenylenediamine (DPD), a salt of N,N-dimethyl-p-phenylenediamine, or a salt of N,N-diethyl-N′,N′-dimethyl-p-phenylenediamine or a combination of potassium iodide and DPD. When the reagent includes potassium iodide, the measured current may be correlated to the total chlorine in the fluid. In another embodiment, the reagent may contain a salt of N,N-diethyl-p-phenylenediamine, and the measured current may be correlated to the amount of free chlorine in the fluid. In yet another embodiment, the reagent may contain a salt of N,N-diethyl-p-phenylenediamine and catalytic amount of potassium iodide, and the measured current may be correlated to the amount of total chlorine in the fluid.

In another aspect, disclosed are methods comprising detecting free chlorine, total chlorine, or both in a fluid using an electrode comprising nanostructures on a substrate, wherein said nanostructures comprise carbon, metal catalyst, and an alkyl protective moiety that forms an alkyl protective moiety layer directly adjacent to at least a portion of said carbon, said metal catalyst, or both.

In yet another aspect, methods are provided for modifying the surface hydrophobicity of nanostructures comprising carbon and metal catalyst on a substrate comprising contacting the nanostructures with a composition comprising an alkyl protective moiety under conditions that permit the formation of an alkyl protective moiety layer directly adjacent to at least a portion of the carbon, the metal catalyst, or both, whereby the contacted nanostructures are characterized as having increased wettability relative to the nanostructures prior to being contacted with the composition. As shown in FIG. 2, untreated CNTs that have been grown on a silicon substrate and immersed in aqueous solution can show poor wettability by water such that air bubbles (marked by black and white arrows) become trapped at the location of the CNT patterns. When CNTs that had been grown on a silicon substrate were protected with an alkyl protective moiety in accordance with the present disclosure, no trapped air bubbles were observed (not shown), indicating that the protection of the CNTs increased the wettability of the CNT arrays. In some embodiments, the nanostructures are contacted with the composition under conditions to give rise to the contacted nanostructures having an effective electrode surface area for electrochemical detection that is substantially equal to the effective electrode surface area of said nanostructures prior to being contacted with the composition.

Alkyl protective moieties that may be used in connection with the disclosed methods for modifying the surface hydrophobicity of nanostructures may include any of the alkyl protective moieties that are otherwise disclosed in the present application, for example, in connection with the disclosed methods for the protection of nano structures. Nonlimiting examples include an alkyl phosphonic acid, an alkyl phosphonate, an alkane, an alkanol, an alkyl carboxylic acid, an alkyl carboxylate, a polyoxyethylene alkyl ether, alkyl amine, alkyl sulfate, alkanethiol, alkyl sulfonate, alkyl quaternary ammonium salt, alkyl betaine, polyoxyethylene alkyl ether sulfate, poly(maleic anhydride-alt-1-octadecene), perfluoro-alkane or any combination thereof.

Also provided are methods for producing nanostructures that are substantially chemically inert comprising contacting nanostructures with a composition comprising an alkyl protective moiety under conditions that permit the formation of an alkyl protective moiety layer directly adjacent to at least a portion of the nano structures, wherein the layer is capable of minimizing nonspecific adsorption of electrochemical species on the nano structures. In other aspects, disclosed are electrodes comprising protected nanostructures disposed on a substrate, wherein the protected nanostructures comprise nanostructures comprising carbon and metal catalyst, the nanostructures further comprising an alkyl protective moiety layer disposed directly adjacent to at least a portion of said carbon, metal catalyst, or both, wherein the protected nanostructures are characterized as having decreased nonspecific adsorption of electrochemical species relative to the nano structures. In other embodiments there are provided protected nanostructures comprising nanostructures comprising carbon and metal catalyst, and further comprising an alkyl protective moiety layer disposed directly adjacent to at least a portion of the carbon, metal catalyst, or both, wherein the protected nanostructures are characterized as having decreased nonspecific adsorption of electrochemical species relative to the nano structures.

Alkyl protective moieties that may be used in connection with the disclosed methods for producing nanostructures that are substantially chemically inert may include any of the alkyl protective moieties that are otherwise disclosed in the present application, for example, in connection with the disclosed methods for the protection of nano structures. Nonlimiting examples include an alkyl phosphonic acid, an alkyl phosphonate, an alkane, an alkanol, an alkyl carboxylic acid, an alkyl carboxylate, a polyoxyethylene alkyl ether, alkyl amine, alkyl sulfate, alkanethiol, alkyl sulfonate, alkyl quaternary ammonium salt, alkyl betaine, polyoxyethylene alkyl ether sulfate, poly(maleic anhydride-alt-1-octadecene), perfluoro-alkane or any combination thereof.

In yet another aspect, there are provided electrodes comprising a conductive structure on a substrate, wherein the conductive structure comprises a conductive layer and an alkyl protective moiety disposed directly adjacent to at least a portion of the conductive layer, wherein said conductive structure is characterized as having one or more of decreased surface hydrophobicity, decreased background non-faradaic current, decreased nonspecific adsorption of electrochemical species, relative to the conductive layer.

Also disclosed are methods comprising contacting a conductive layer with a composition comprising an alkyl protective moiety under conditions that permit the formation of an alkyl protective moiety layer directly adjacent to at least a portion of the conductive layer, wherein the alkyl protective moiety layer is capable of minimizing the nonspecific adsorption of electrochemical species on the conductive layer.

In accordance with the disclosed electrodes and methods, the conductive layer may comprise carbon nanostructures, diamond, gold, graphite (e.g., graphene, including 2D-3D graphene structures, screen printing carbon nanotube paste, or any combination thereof), platinum, or any combination thereof. For example, the conductive layer may comprise a monolayer of gold or carbon (e.g., graphene) or thick screen printing carbon nanotube paste.

The conductive layer may be present on all or part of one or more surfaces of the substrate. The conductive layer may be present on the substrate in the form of patches, strips, spots, any geometrical or irregular shape, or any combination thereof. The conductive layer may be present on the substrate in the form of a patterned array, for example, an ordered array of spots, strips, squares, and the like, or any combination thereof. The conductive layer may be substantially flat, i.e., having a dimension along the axis parallel to the surface of the substrate that is at least two times greater than a dimension that is perpendicular to the axis parallel to the surface of the substrate. For example, the conductive layer may comprise a monolayer of gold or carbon (e.g., graphene). In other embodiments, the conductive layer may comprise elements that are not substantially flat, such as, for example, granules, spheres, or rods. The conductive layer may comprise at least one nanoscale dimension, for example, at least one dimension that is in the range of about 1 nm to about 500 nm, about 1 nm to about 200 nm, about 1 nm to about 100 nm, about 1 nm to about 50 nm, about 1 nm to about 20 nm, or about 1 nm to about 10 nm.

### EXAMPLES

### 1. Exemplary General Procedure for the Protection of Carbon Nanotubes on a Substrate

A protocol was developed for the protection of carbon nanotubes on a substrate with an alkyl protective moiety:

1) A silicon chip (1 cm×1 cm) on which carbon nanotubes (CNTs) had been grown using standard procedures was stored in air for at least 3 days after growth of carbon nanotubes. Following storage, the chip was immersed in a solution comprising the alkyl protective moiety (2 mM in THF, 1 mL) in a capped small vial (I.D. ˜2.5 cm) for 3 h.

2) The treated sample was removed from the vial, dried in air briefly and placed in a new sample vial. The vial was purged with N₂ stream for 30 seconds and then securely capped.

3) The capped vial was heated at 140° C. for 24˜48 h.

4) The sample was cooled to ambient temperature in the capped vial, then removed from the vial with forceps and was rinsed with THF (10×) before it was dried in air. The dried chip was ready for wire-bonding.

5) For total chlorine detection applications when KI (potassium iodide) is used, in order to minimize the nonspecific adsorption of I₂ on CNT chip, a CNT chip may be subjected to a further protecting treatment with poly(oxyethylene) alkyl ether after being first treated with alkane. In such instances, the chip from Step 4 was immersed in a solution of poly(oxyethylene) alkyl ether (2 mM in THF, 1 mL) in a capped small vial (I.D. ˜2.5 cm) for 3 h. Step 2, 3 and 4 were followed to furnish a CNT chip with minimal nonspecific adsorption for I₂.

### 2. Protection of Carbon Nanotubes on a Substrate

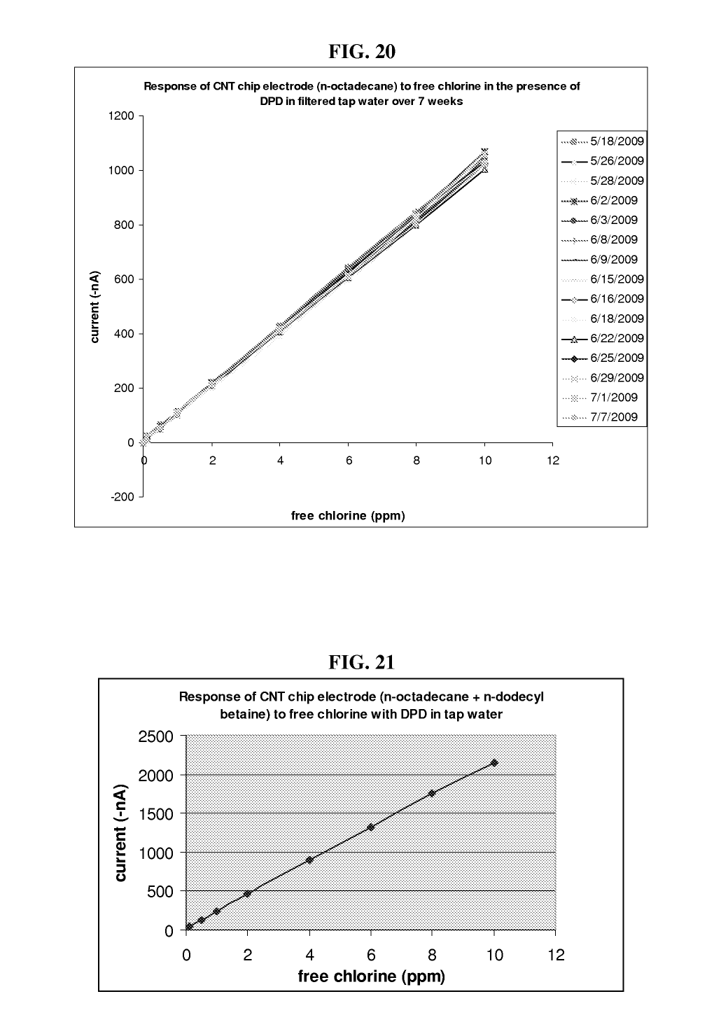

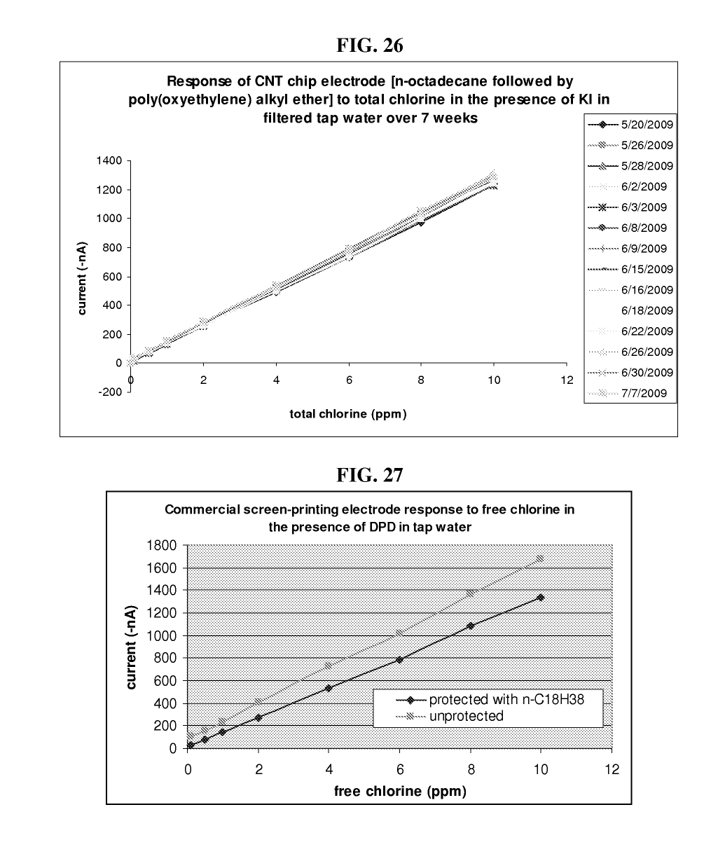

A chip having components that were protected according to the present disclosure using 1-octylphosphonic acid and comprising carbon nanotubes (CNTs) on a silicon substrate was treated with 5% NaOCl solution under microscope, no bubble formation was observed, indicating that the nickel is effectively protected from oxidation. Furthermore, the patterned CNTs after protection were hydrophilic, as no bubble formation was evident on the surface under microscope. Most importantly, the protected CNT chip was stable for over 30 days when used to test free chlorine (in the presence of DPD) (FIG. 20) and total chlorine (in the presence of potassium iodide) (FIG. 26) in water.

### 3. Minimization of Non-Specific Adsorption

Following treatment with alkyl protective moiety in accordance with the present disclosure (for example, under the general protocol provided in Example 1, supra), the surfaces of the treated nanostructures is stabilized, and as a result, may serve as highly effective electrodes in aqueous applications with long-term stability. For example, the nanostructures can be used to detect free chlorine in water with and without the use of N,N-diethyl-p-phenylenediamine (DPD). However, nanostructures that are protected with alkylphosphonic acids or phosphonates, alkanes, alkanols, alkyl carboxylic acids or carboxylates may require additional processing when iodine is involved in total chlorine detection. Iodine is extremely hydrophobic, and tends to be adsorbed onto electrodes that have undergone protection with alkylphosphonic acids or phosphonates, alkanes, alkanols, alkyl carboxylic acids or carboxylates. The adsorption is most severe with electrodes that have been protected with alkanes. To illustrate, a CNT electrode protected with only n-octadecane was used to measure a solution with 0.46 ppm total chlorine in the presence of potassium iodide. The current changed from −71.13 nA (first measurement) to −77.71 nA (seventh measurement)—almost a 10% increase. At lower concentrations of total chlorine (˜50 ppb), the adsorption effect is even more dramatic with nanostructures that have been protected with n-octadecane. Nanostructures that have been protected with alkyl phosphonic acids or alkyl carboxylic acids have less tendency to adsorb iodine than those with alkanes. A linear response can be obtained using alkyl phosphonic acids or alkyl carboxylic acids for the protection of nanostructures for use in total chlorine detection with KI when the total chlorine concentration is above 0.5 ppm.

The present inventors have discovered that poly(ethylene glycol) can be used to minimize non-specific adsorption by nanostructures. In one example, polyoxyethylene alkyl ethers were used to provide further protection to CNT electrodes that had already been protected with n-octadecane. Without intending to be bound by any particular theory of operation, it is believed that the hydrophobic alkyl portion of the polyoxyethylene alkyl ethers would predominately interact with n-octadecane on CNT surface, forcing the hydrophilic polyoxyethylene moiety to form a hydrophilic layer that can minimize iodine adsorption by the electrode. Indeed, CNT nanostructure electrodes that were protected with polyoxyethylene alkyl ether following protection with n-octadecane demonstrated a stable linear response below 50 ppb total chlorine level in the presence of KI.

### 4. Reagentless Detection of Free Chlorine and NH₂Cl

A free chlorine solution in a buffer solution (e.g., 2.5 mM sodium phosphate solution in de-ionized water having a pH of 7.3 to approximate tap water in conductivity and pH, or tap water saturated with CO₂) was prepared. An auxiliary electrode, a reference electrode, and a working electrode comprising nanostructures on a substrate that had been protected in accordance with presently disclosed methods were exposed to the solution. A voltage (about −0.5 to about 1 V) was applied between the working electrode and the reference electrode for a suitable period of time (e.g., from about 5 to about 30, preferably from about 5 to about 20 seconds, more preferably about 10 seconds), whereby a current was generated between the working electrode and the auxiliary electrode. The current that was generated as a result of the application of voltage was measured, and the free chlorine concentration in the sample was determined therefrom in accordance with methods that are well-understood among those having ordinary skill in the art. Working electrodes comprising nanostructures on a substrate, wherein the nanostructures have been protected in accordance with the present disclosure, have superior performance in terms of long-term stability and reproducibility for free chlorine determination in a water sample.

### Example 4.1

### Octadecylphosphonic acid (ODPA)

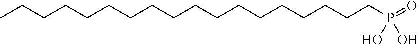

or 1-octylphosphonic acid (OPA):

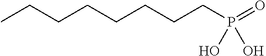

When tested in 0.1M PBS with 0.01 M KCl (pH 5.5) for 5 seconds, a CNT chip electrode protected with ODPA gave linear response (R²>0.999) to free chlorine concentration (FIG. 5). Test condition: background chronoamperometry twice for 30 seconds, then stock addition and mixing, then applied voltage for 5 seconds and the current at 5 seconds recorded, then test cell and chip electrode rinsed twice with deionized water, then the same sequence repeated for the next free chlorine concentration. CNT chip electrodes protected with OPA yielded similar results (not shown) when tested under the above test conditions.

### Example 4.2

### 1-Octadecanol

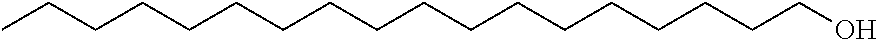

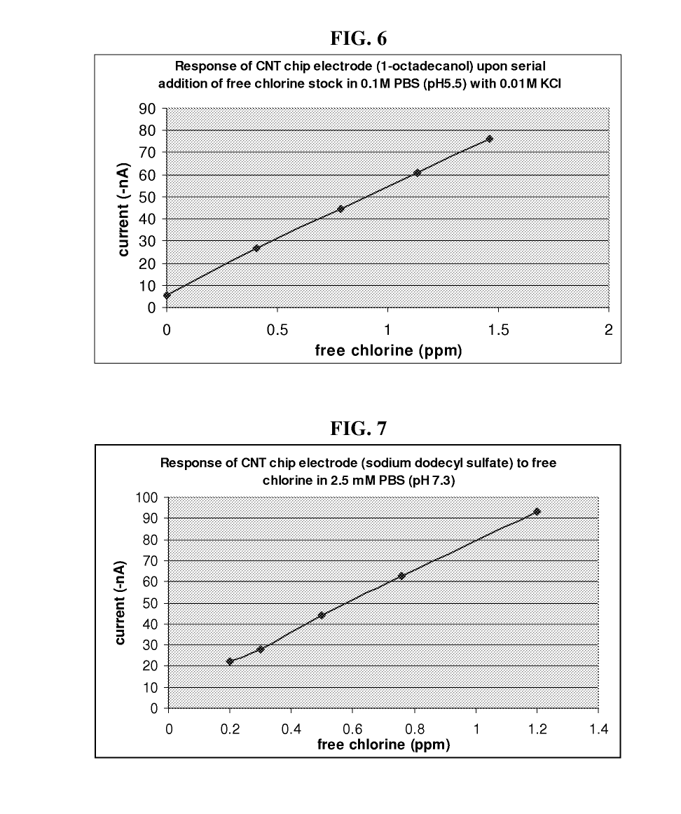

A CNT chip electrode protected with 1-octadecanol tested in 0.1 M PBS with 0.01M KCl (pH 5.5) gave linear response (R²>0.999) upon serial addition of free chlorine stock solution (FIG. 6). Test condition: applied voltage for 5 seconds after each stock addition and vigorous mixing for 10 seconds.

### Example 4.3

### Sodium dodecyl sulfate (SDS)

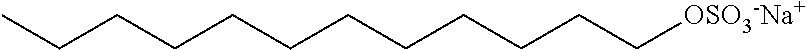

A CNT chip electrode protected with sodium dodecyl sulfate was suitable for free chlorine detection after a stabilization period. Linear response was obtained in 2.5 mM PBS (pH 7.3) (R²>0.999) (FIG. 7). Test condition: following background amperometry in 2.5 mM PBS for 60 sec and another 60 sec followed by the addition of free chlorine stock solution and mixing, the test was run for 10 sec and the end current was recorded.

### Example 4.4

### Tetradecyltrimethylammonium chloride

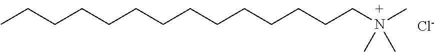

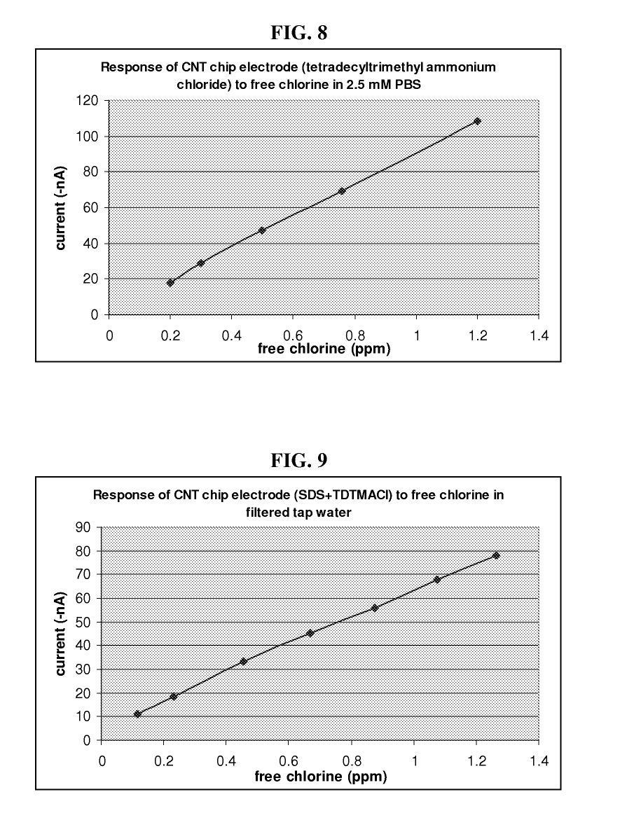

A CNT chip electrode protected with tetradecyltrimethylammonium chloride was suitable for free chlorine detection after a stabilization period. Linear response was obtained in 2.5 mM PBS (pH 7.3) (R²>0.999) (FIG. 8). Test condition: after background chronoamperometry in 2.5 mM PBS for 60 sec and another 60 sec followed by the addition of free chlorine stock solution and mixing, the test was run for 10 sec and the end current was recorded.

### Example 4.5

### Sodium dodecyl sulfate+tetradecyltrimethylammonium chloride (SDS+TDTMACl) (1:1 molar ratio)

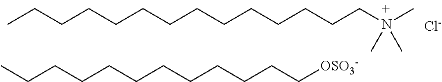

A CNT chip electrode protected with sodium dodecyl sulfate and tetradecyltrimethylammonium chloride (SDS+TDTMACl) (1:1 molar ratio) was suitable for free chlorine detection after a stabilization period. Linear response could be obtained in freshly filtered tap water (R²>0.99) (FIG. 9). Test condition: after background chronoamperometry in freshly filtered tap water for 60 sec and another 60 sec followed by the addition of free chlorine stock solution and mixing, the test was run for 10 sec and the end current was recorded.

### Example 4.6

### n-octadecane+Brij®78 (C18EG20)

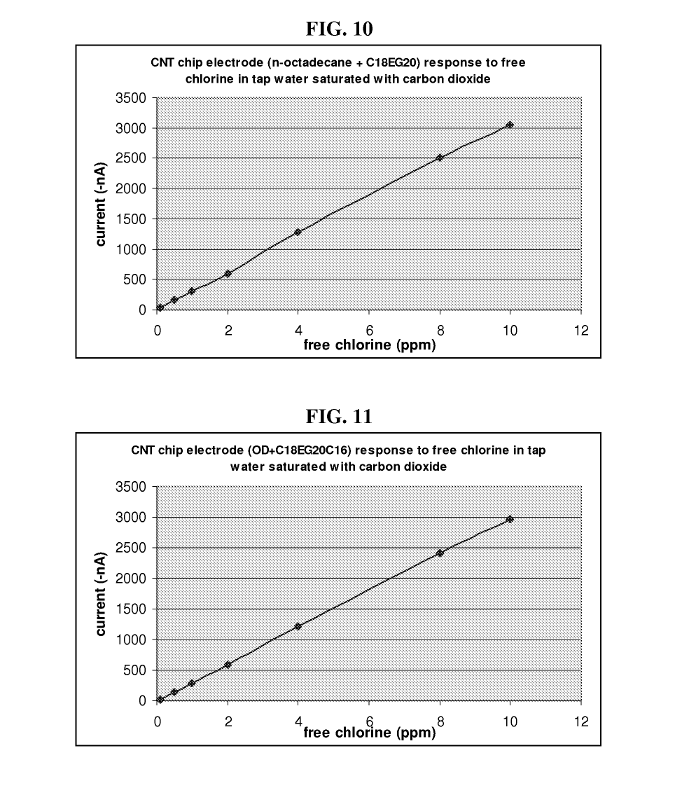

CNT chip electrodes protected with n-octadecane followed by poly(oxyethylene) alkyl ether are most suitable for free chlorine detection. A CNT electrode treated with n-octadecane followed by Brij®78 (C18EG20) responded to free chlorine with good linearity (R²>0.999) when tested in tap water saturated with CO₂ (pH 5.1) (FIG. 10). Test condition: tap water was stored at ambient temperature overnight, saturated with CO₂ to pH 5.1. After the addition of free chlorine stock solution and mixing, the test was run at 0V for 10 sec and the end current was recorded.

### Example 4.7

### n-octadecane+Brij®78 hexadecyl ether (C18EG20C16)

A CNT electrode treated with n-octadecane followed by Brij®78 hexadecyl ether (C18EG20C16) responded to free chlorine with good linearity (R²>0.999) when tested in tap water saturated with CO₂ (pH 5.1) (FIG. 11). Test condition: tap water was stored at ambient temperature overnight, saturated with CO₂ to pH 5.1. After the addition of free chlorine stock solution and mixing, the test was run at 0V for 10 sec and the end current was recorded.

### Example 4.8

### n-octadecane+Brij®56 sulfate (C16EG10SO₃⁻)

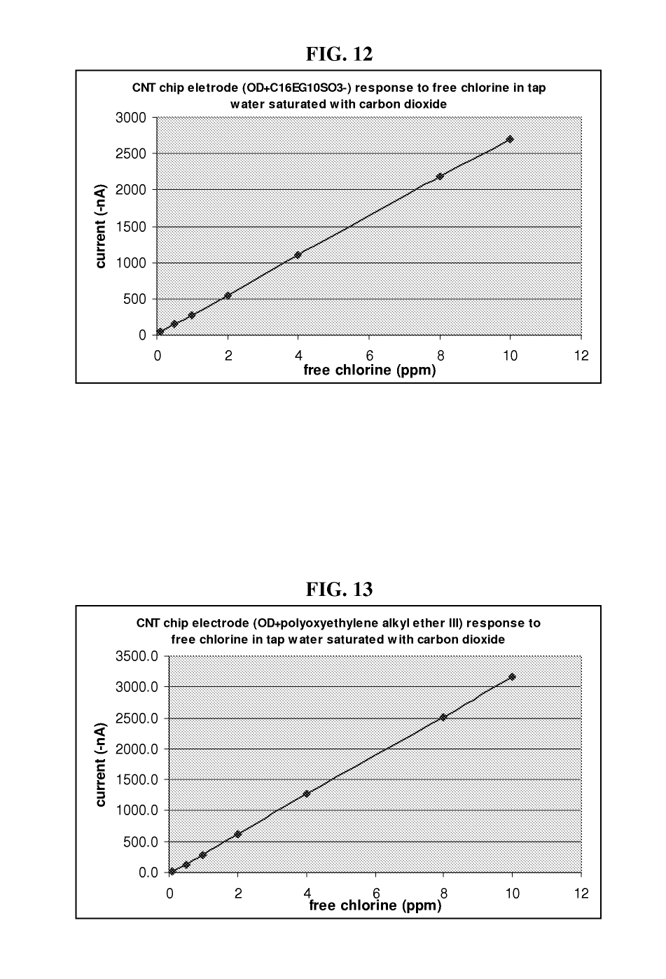

A CNT electrode treated with n-octadecane followed by Brij®56 sulfate (C16EG10SO₃⁻) responded to free chlorine with good linearity (R²>0.999) when tested in tap water saturated with CO₂ (pH 5.1) (FIG. 12). Test condition: tap water was stored at ambient temperature overnight, saturated with CO₂ to pH 5.1. After the addition of free chlorine stock solution and mixing, the test was run at 0V for 10 sec and the end current was recorded.

### Example 4.9

### n-octadecane+polyoxyethylene alkyl ether (III)

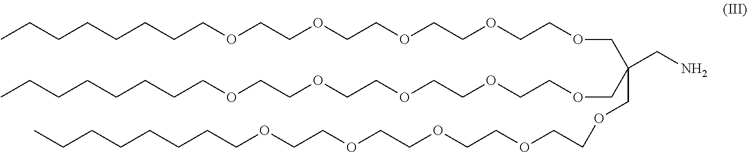

A CNT electrode treated with n-octadecane followed by polyoxyethylene alkyl ether (III) also responded to free chlorine with good linearity (R²>0.999) when tested in tap water saturated with CO₂ (pH 5.1) (FIG. 13). Test condition: tap water was stored at ambient temperature overnight, saturated with CO₂ to pH 5.1. After the addition of free chlorine stock solution and mixing, the test was run at 0V for 10 sec and the end current was recorded.

### Example 4.10

### Poly(maleic anhydride-alt-1-octadecene)

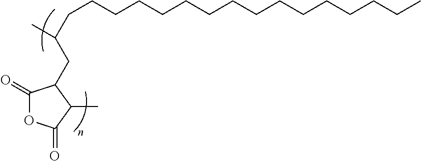

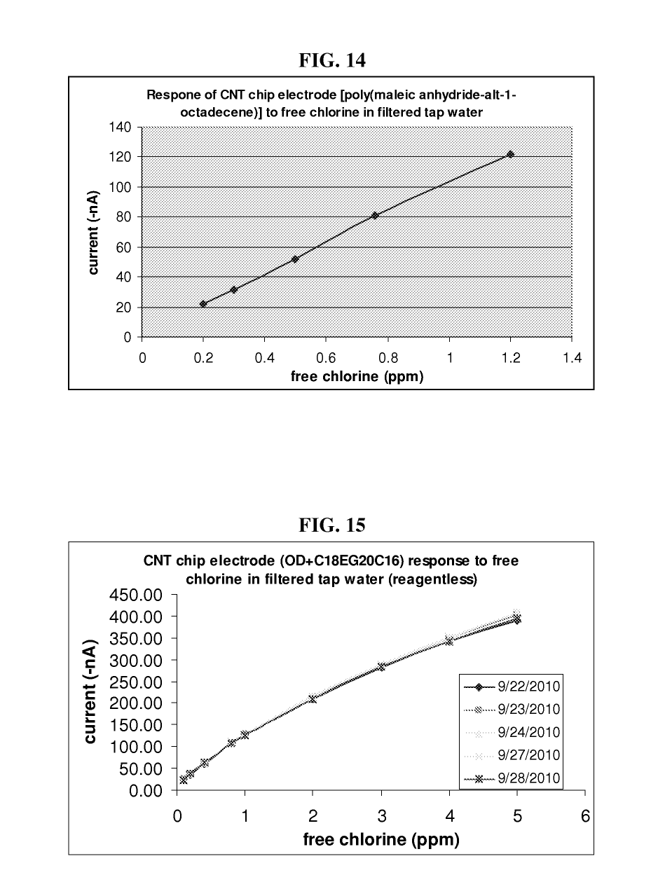

A CNT chip electrode protected with poly(maleic anhydride-alt-1-octadecene) responded to free chlorine with good linearity (R²=0.999) when tested in tap water that was filtered with activated carbon to remove residual chlorine (FIG. 14). Test condition: after background chronoamperometry in filtered tap water for 60 sec and another 60 sec followed by the addition of free chlorine stock addition and mixing, the test was run for 10 sec and the end current was recorded.

### Example 4.11

A CNT electrode treated with n-octadecane followed by Brij®78 hexadecyl ether (OD+C18EG20C16) responded to free chlorine with good stability when tested in filtered tap water (no additional reagent) for 5 days (FIG. 15). Test condition: fresh filtered tap water was stored at ambient temperature. After the addition of free chlorine stock solution and mixing, the test was run at 0V for 10 sec and the end current was recorded.

### Example 4.12

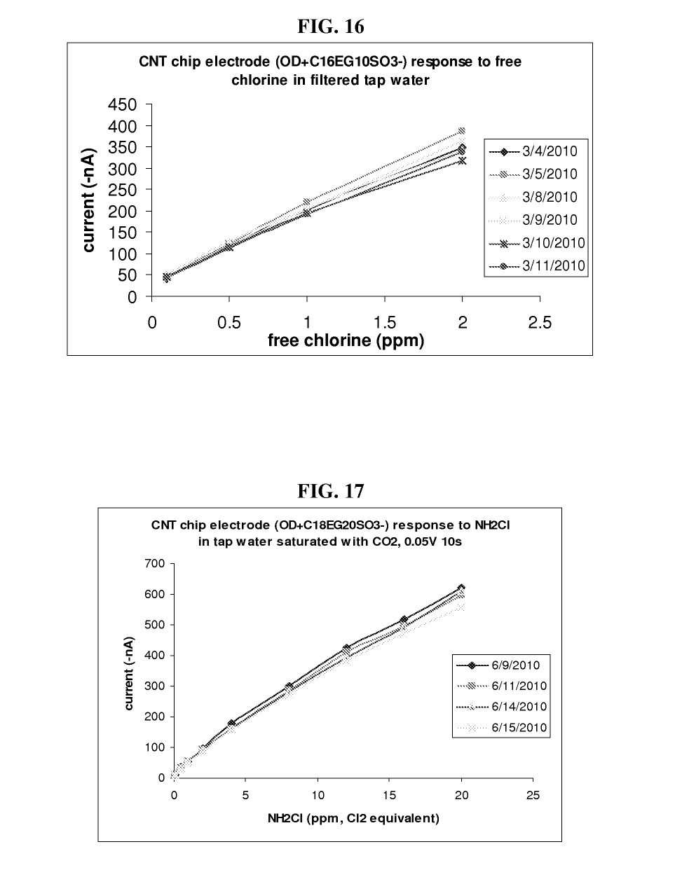

A CNT electrode treated with n-octadecane followed by Brij®56 sulfate (C16EG10SO₃⁻) also responded to free chlorine with good stability and linearity (below 1 ppm) when tested in filtered tap water (FIG. 16). Test condition: fresh filtered tap water was stored at ambient temperature. After the addition of free chlorine stock solution and mixing, the test was run at 0V for 10 sec and the end current was recorded.

### Example 4.13

A CNT electrode treated with n-octadecane followed by Brij®78 sulfate (C18EG20SO₃⁻) responded to NH₂Cl with good long-term stability up to 20 ppm (Cl₂ equivalent) when tested in overnight tap water saturated with CO₂ (FIG. 17). Test condition: tap water was stored at ambient temperature overnight and then saturated with CO₂. After the addition of NH₂Cl stock solution and mixing, the test was run at 0.05V for 10 sec and the end current was recorded.

### Example 4.14

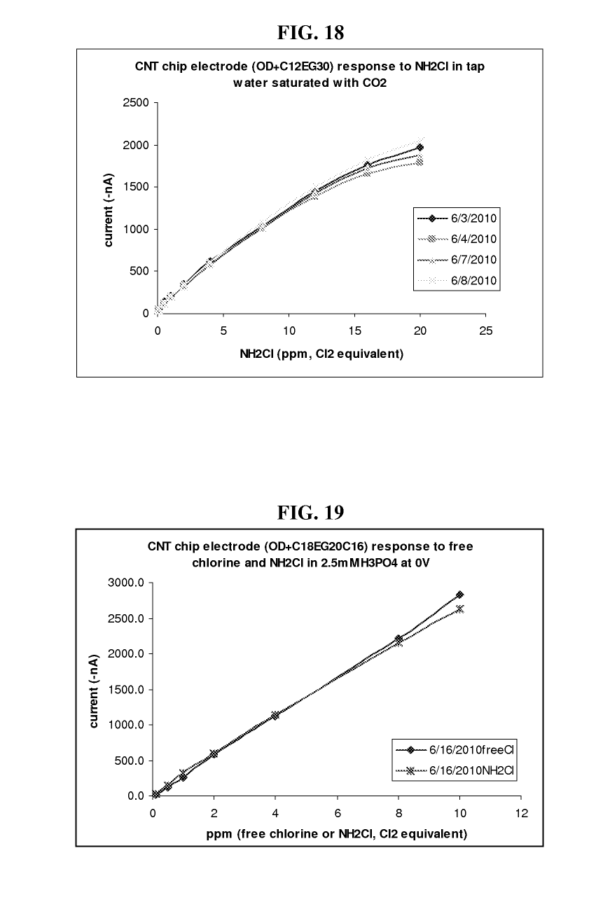

A CNT electrode treated with n-octadecane followed by Brij®35 (C12EG30) responded to NH₂Cl with good long-term stability up to 20 ppm (Cl₂ equivalent) when tested in overnight tap water saturated with CO₂ (FIG. 18). Test condition: tap water was stored at ambient temperature overnight and then saturated with CO₂. After the addition of NH₂Cl stock solution and mixing, the test was run at 0.05V for 10 sec and the end current was recorded.

### Example 4.15

A CNT electrode treated with n-octadecane followed by Brij®78 hexadecyl ether (OD+C18EG20C16) responded to both free chlorine and NH₂Cl in 2.5 mM H₃PO₄ (pH 2.9) in deionized water with similar slope and good linearity (FIG. 19). Test condition: 2.5 mM H₃PO₄ (pH 2.9) in deionized water was used as testing solution. Upon the addition of free chlorine or NH₂Cl stock solution and mixing, the test was run at 0V for 10 sec and the end current was recorded.

### 5. Detection of Free Chlorine and/or Total Chlorine with Reagents

### 5.1. Detection of Free Chlorine with N,N-diethyl-p-phenylenediamine (DPD)

Free chlorine detection with N,N-diethyl-p-phenylenediamine (DPD) may be performed as follows. A solution of a salt of DPD and the sample with suitable pH (e.g., pH 6-6.5) is prepared. An auxiliary electrode, a reference electrode, and a working electrode comprising nanostructures on a substrate that have been protected in accordance with presently disclosed methods are exposed to the solution. A voltage (e.g., about −0.5 to about 1V) is applied between the working electrode and the reference electrode for a suitable period of time (e.g., from about 5 to about 30, preferably from about 5 to about 20 seconds, more preferably about 10 seconds), whereby a current is generated between the working electrode and the auxiliary electrode. The current that is generated as a result of the application of voltage is measured, and the free chlorine concentration in the sample is determined therefrom in accordance with methods that are well-understood among those having ordinary skill in the art. Working electrodes comprising nanostructures on a substrate, wherein the nanostructures have been protected in accordance with the present disclosure, have superior performance in terms of long-term stability and reproducibility when used with DPD for free chlorine determination in a water sample.

### Example 5.1.1

CNT chip electrodes protected with n-octadecane, poly(oxyethylene) alkyl ether, or n-octadecane followed by poly(oxyethylene) alkyl ether are most suitable for free chlorine detection with DPD. For example, a CNT chip electrode that had been protected with n-octadecane in accordance with the present disclosure was most suitable for free chlorine detection when used in combination with DPD sulfate salt. The test was performed in 1 mM H₃PO₄ solution in deionized water to obtain linear response. Linear response was also obtained in tap water (filtered with activated carbon to remove residual chlorine) upon addition of DPD sulfate salt and free chlorine stock solution. Under these testing conditions, the CNT chip electrode protected with n-octadecane showed superior stability and reproducibility over a combined period of more than four months; FIG. 20 shows the response of an electrode comprising carbon nanotubes that has been protected with n-octadecane upon addition of free chlorine in the presence of DPD sulfate in filtered tap water over seven weeks.

### Example 5.1.2

### n-Octadecane

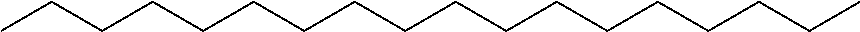

and
n-dodecyl betaine:

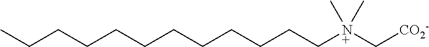

A CNT chip electrode protected with n-octadecane then n-dodecyl betaine was tested in filtered tap water with 0.5 mM DPD sulfate and was found to give a linear response (R²>0.999) upon the addition of free chlorine stock solution (FIG. 21). Test condition: the chip electrode was rinsed with deionized water, then immersed in filtered tap water, followed by the addition of DPD sulfate solution and free chlorine stock solution. After mixing, the test was run for 10 seconds and the end current was recorded. This chip was also tested with 0.1 mM KI and 0.5 mM H₃PO₄ in filtered tap water and was found to give a linear response (R²>0.999) upon the addition of free chlorine stock solution (data not shown), albeit with a higher response slope compared to DPD.

### 5.2. Detection of Total Chlorine with DPD and Catalytic Amount of KI

Most commercial free/total chlorine colorimeters utilize DPD and a catalytic amount of KI to determine total chlorine level, as KI can catalyze the reduction of free chlorine (HOCl and OCl⁻) and chloramines (NH₂Cl, NHCl₂ and NCl₃). However, colorimetric methods have serious drawbacks when the total chlorine level is above 2 ppm. In fact, most commercial free/total chlorine colorimeters have detection range below 4 ppm.

It has been discovered that CNT chip electrodes protected with n-octadecane followed by poly(oxyethylene) alkyl ether are most suitable for total chlorine detection with DPD and catalytic amount of KI. For example, a solution of DPD and catalytic KI and the sample water with suitable pH (e.g., pH 6-6.5) was prepared. An auxiliary electrode, a reference electrode, and a working CNT chip electrode that had been protected with n-octadecane followed by poly(oxyethylene) alkyl ether was exposed to the solution. A predetermined voltage was then applied between the working electrode and the reference electrode for 10 seconds and the end current correlated well with the total chlorine level in the sample (0 to 10 ppm), thus demonstrating the superior performance of CNT chip electrodes that are protected in accordance with the present disclosure over commercial free/total chlorine colorimeters.

### Example 5.2.1

To illustrate, a CNT chip electrode was first calibrated to have a response equation as follows:

Current Y (−nA)=224.75×(ppm)+20.54. The calibrated CNT chip electrode was used to measure reductive current of a given sample at a predetermined voltage. The current recorded at the end of 10 seconds was converted to free/total chlorine level according to the above calibration equation. Tap water sample (5 mL) (with 0.01 ppm free chlorine and 0.09 ppm total chlorine based on Hach DR/890 colorimeter) were added, in sequence, DPD sulfate solution (0.1 M, 25 μL) and free chlorine stock to measure free chlorine level. Total chlorine level was measured by adding in sequence DPD sulfate solution (0.1 M, 25 μL), free chlorine stock, NH₂Cl stock and KI solution (0.02 M, 5 μL). As shown in Table 1, without catalytic amount of KI, CNT chip electrode could be used to determine free chlorine level in the presence of DPD alone (Entries 1-4, Entry 10) and the addition of NH₂Cl has little effect on the free chlorine level reading (Entries 5 and 9). When catalytic amount of KI was introduced, the current reading corresponded well to the total chlorine level in the sample (Entries 6-8).

TABLE 1
Determination of total chlorine in tap water
in presence of DPD and catalytic amount of KI

| | | | Free/total |
|---|---|---|---|
| | | Current | chlorine |
| Entry | Tap Water (5 mL) | (−nA) | (ppm) |
| 1 | Tap water + DPD + 0.5 ppm NaOCl | 140.9 | 0.536 |
| 2 | Tap water + DPD + 0.5 ppm NaOCl | 135.1 | 0.510 |
| 3 | Tap water + DPD + 1 ppm NaOCl | 246.5 | 1.005 |
| 4 | Tap water + DPD + 2 ppm NaOCl | 471.2 | 2.005 |
| 5 | Tap water + DPD + 1 ppm NaOCl + | 263.9 | 1.083 |
| | 1 ppm NH2Cl | | |
| 6 | Tap water + DPD + 0.5 ppm + NaOCl + | 245.2 | 1.000 |
| | 0.5 ppm NH2Cl + KI | | |
| 7 | Tap water + DPD + 1 ppm + NaOCl + | 436.5 | 1.851 |
| | 1 ppm NH2Cl + KI | | |
| 8 | Tap water + DPD + 2 ppm + NaOCl + | 904.6 | 3.934 |
| | 2 ppm NH2Cl + KI | | |
| 9 | Tap water + DPD + 1 ppm NaOCl + | 259.9 | 1.065 |
| | 1 ppm NH2Cl | | |
| 10 | Tap water + DPD + 1 ppm NaOCl | 243.7 | 0.993 |

### 5.3. Detection of Total Chlorine with KI

It has been found that total chlorine level in a water sample can also be determined without the use of DPD. The iodine formed in the reaction between iodide and chlorine/chloramines may be reduced at the working electrode comprising nanostructures on a substrate, wherein the nanostructures have been protected in accordance with the present disclosure. The current that is generated as iodine is reduced is proportional to the total chlorine concentration in the sample and the total chlorine concentration is thus determined. However, due to the hydrophobic nature of iodine, working electrodes protected with alkane (n-octadecane), alkyl phosphoric acid (OPA and ODPA) or alky carboxylic acid (stearic acid) alone appear to adsorb iodine to some extent. Nonetheless, when total chlorine concentration is greater than 0.5 ppm, CNT chip electrodes protected with alkyl phosphonic acid or alkyl carboxylic acid alone can be used for total chlorine detection in the presence of KI with superior stability and reproducibility. Other protecting agents such as perfluoroalkane, alkylsulfonate and alkylamine can also be used to protect CNT electrode surfaces for total chlorine detection with KI.

### Example 5.3.1

### Stearic Acid

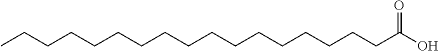

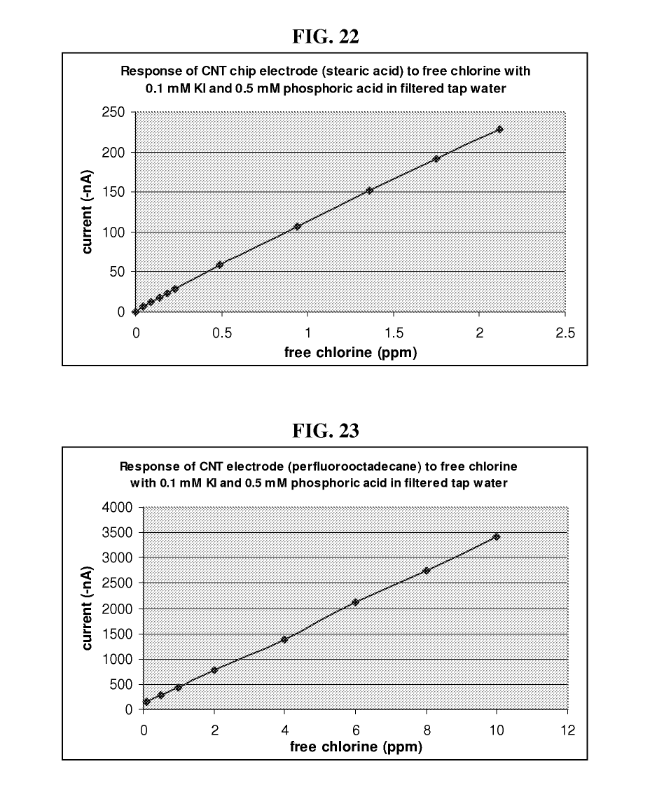

A CNT chip electrode protected with stearic acid was found to respond to free chlorine in the presence of 0.1 mM KI with good linearity (R²>0.999) when tested in tap water (buffered with 0.5 mM H₃PO₄) that was filtered with activated carbon to remove residual chlorine (FIG. 22). Test condition: after background chronoamperometry in filtered tap water for 30 sec and another 30 sec followed by the addition of KI, H₃PO₄ and free chlorine stock and mixing, the test was run for 10 sec and the end current was recorded.

### Example 5.3.2

### Perfluorooctadecane

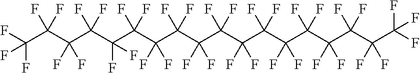

A CNT chip electrode protected with perfluorooctadecane was found to respond to free chlorine in the presence of 0.1 mM KI with good linearity (R²>0.999) when tested in tap water (buffered with 0.5 mM H₃PO₄) that was filtered with activated carbon to remove residual chlorine (FIG. 23). Test condition: after filtered water was mixed with KI, H₃PO₄ and free chlorine stock, the test was run at 0V for 10 sec and the end current was recorded.

### Example 5.3.3

### Dioctadecylamine

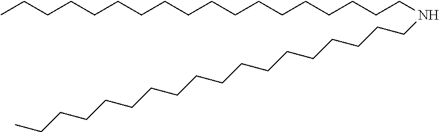

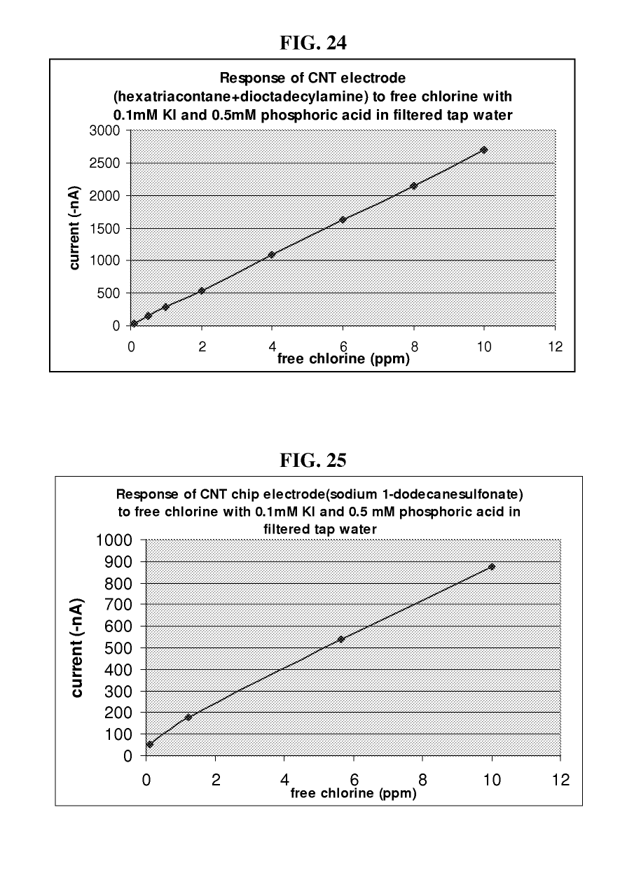

A CNT chip electrode protected with dioctadecylamine over hexatriacontane was found to respond to free chlorine in the presence of 0.1 mM KI with good linearity (R²>0.999) when tested in tap water (buffered with 0.5 mM H₃PO₄) that was filtered with activated carbon to remove residual chlorine (FIG. 24). Test condition: after filtered water was mixed with KI, H₃PO₄ and free chlorine stock, the test was run at 0V for 10 sec and the end current was recorded.

### Example 5.3.4

### Sodium 1-dodecane sulfonate

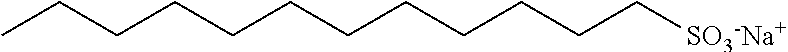

A CNT chip electrode protected with sodium 1-dodecanesulfonate was suitable for total chlorine detection with KI after a stabilization period. Linear response is obtained in filtered tap water from ˜1 ppm to 10 ppm (R²>0.998) (FIG. 25). Test condition: after background chronoamperometry in filtered tap water for 60 sec followed by the addition of KI and H₃PO₄ solution, free chlorine stock solution and then mixing, the test was run for 10 sec and the end current was recorded.

### Example 5.3.5

The nonspecific adsorption of iodine by the working electrode makes low concentration chlorine (less than 50 ppb) difficult to accurately measure. By protecting the electrode with polyoxyethylene alkyl ether (Brij®30 or Brij®56, Croda International PLC, East Yorkshire, England) over n-octadecane, the adsorption of iodine is minimized and as a result, the minimal detection limit of these electrodes could reach down to 6 ppb level.

For example, a CNT chip electrode that was first protected with n-octadecane followed by protection with poly(oxyethylene) alkyl ether (Brij®30) was suitable for free chlorine detection when used in combination with DPD sulfate salt and total chlorine detection when used with KI. A linear response was obtained in tap water (filtered with activated carbon to remove residual chlorine) or in unfiltered tap water with no residual chlorine. Under these testing conditions, the CNT chip electrode protected with n-octadecane followed by poly(oxyethylene) alkyl ether (Brij®30) demonstrated superior stability and reproducibility over a combined period of more than four months. FIG. 26 shows the response of an electrode comprising carbon nanotubes that was protected with n-octadecane followed by poly(oxyethylene) to total chlorine in the presence of 0.1 mM KI and 0.5 mM H₃PO₄ in filtered tap water over seven weeks.

### 6. Protection of Conductive Layer

### 6.1 Protection of Screen-Printing Carbon Nanotube Paste Electrode

A screen-printing carbon nanotube paste electrode was first protected with n-octadecane as follows. The circular working electrode area was drop-cast with a 10 mM n-C₁₈H₃₈ solution in THF (2×5 μL), dried in air and then warmed at 140° C. under Ar for 24 hours. The electrode was cooled to ambient temperature, rinsed with THF (10×) and dried in air.

The as-protected electrode was ready for free chlorine detection when used in combination with DPD sulfate salt. Linear response (0-10 ppm) was obtained in tap water (filtered with activated carbon to remove residual chlorine) upon DPD sulfate salt and free chlorine stock solution addition. Under these testing conditions, the electrode protected with n-octadecane showed drastically reduced adsorption for analytes as compared to the unprotected electrode.

Table 2, below, provides data for the free chlorine response of an unprotected, screen-printing CNT electrode and the same electrode that has been protected with n-C₁₈H₃₈ in accordance with the present disclosure, each in the presence of DPD in tap water.

TABLE 2
Difference in response to free chlorine in the presence
of DPD between a screen-printing electrode and its auxiliary
part protected with n-C₁₈H₃₈

| | Unprotected | Screen-Printing |
|---|---|---|
| | Screen-Printing | Electrode Protected |
| Free Chlorine | Electrode | With n-C₁₈H₃₈ |
| (ppm) | Current (−nA) | Current (−nA) |
| 0.1 | 106.2 | 26.25 |
| 0.5 | 158.7 | 79.55 |
| 1.0 | 233.6 | 142.5 |
| 2.0 | 407.5 | 273.20 |
| 4.0 | 722.7 | 536.4 |
| 6.0 | 1013 | 787.7 |
| 8.0 | 1364 | 1082.0 |
| 10.0 | 1676 | 1340.0 |
| 0.1 | 172.6 | 26.03 |
| 0.1 | 165.8 | 23.03 |
| 0.1 | | 23.03 |

As shown FIG. 27, both the unprotected screen-printing CNT electrode and an electrode protected with n-C₁₈H₃₈ appeared to yield a linear response (R²=0.9997) to free chlorine in the presence of DPD in tap water. However, a close examination of unprotected electrode revealed that after a high concentration measurement (e.g., 10 ppm), the current reading for 0.1 ppm rose from 106.2 nA to 172.6 nA, indicative of strong analyte adsorption. On the contrary, the electrode that was protected in accordance with the present disclosure gave almost identical current readings for 0.1 ppm before and after the 10 ppm measurement, i.e., 26.25 nA (before) and 26.03 nA, well within the method margin of error. It is therefore evident that protection of electrode could dramatically improve its performance as electrode for free chlorine detection in the presence of DPD.

### 6.2 Protection of Diamond Electrode Surface

A diamond electrode was first protected with n-octadecane as follows. The circular working electrode area was drop-cast with a 10 mM n-C₁₈H₃₈ solution in THF (2×5 μL), dried in air and then warmed at 140° C. under Ar for 24 hours. The electrode was cooled to ambient temperature, rinsed with THF (10×) and dried in air. The electrode surface was drop-cast with a 10 mM C18EG20C16 solution in THF (2×5 μL), dried in air and then warmed at 140° C. under Ar for 24 hours. Upon cooling to ambient temperature, the electrode was rinsed with THF (10×) and dried in air.

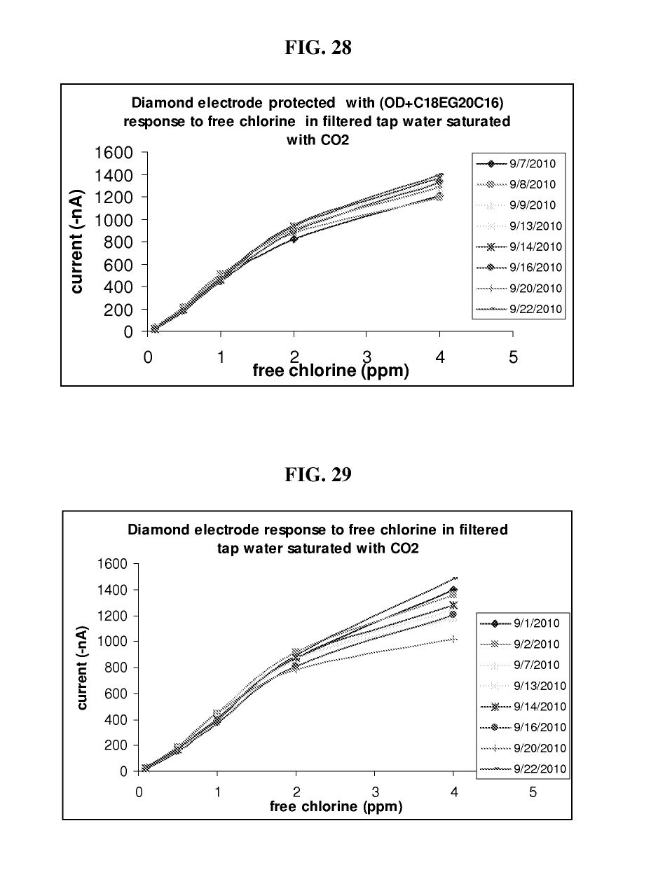

The as-protected diamond electrode was tested for free chlorine response in tap water (filtered with activated carbon to remove residual chlorine) saturated with CO₂. As shown in FIG. 28, the as-protected diamond electrode gave stable response to free chlorine (0˜4 ppm) over two weeks. The free chlorine response data were reasonably tight, suggesting a stable electrode surface after protection with C18EG20C16 over n-C₁₈H₃₈.

In contrast, a diamond electrode without protection yielded considerably less stable response to free chlorine when tested under identical condition (0˜4 ppm) (FIG. 29) over the same period of time. The free chlorine response data were much less tight, suggesting an unstable electrode surface. It is therefore clear that protection of electrode with an alkyl protective moiety layer stabilizes the electrode surface to give stable free chlorine response.

The disclosures of each patent, patent application, and publication cited or described in this document are hereby incorporated herein by reference, in their entirety.

1. A method for the protection of nanostructures comprising carbon and metal catalyst on a substrate comprising:
contacting said nanostructures with a composition comprising an alkyl protective moiety under conditions that permit the formation of an alkyl protective layer disposed directly adjacent to at least a portion of said metal catalyst, said carbon, or both.

2. The method according to claim 1 wherein said carbon nanostructures comprise carbon nanotubes.

3-4. (canceled)

5. The method according to claim 1 wherein said alkyl protective moiety comprises a compound having the general formula (I):
R₁(CH₂)ₙR₂X (1)
wherein
R₁ represents hydrogen, or a C₁₋₅₀ straight or branched alkyl or alkenyl, optionally substituted with one or more halogen atoms;
R₂ represents a single bond, an aromatic or alicyclic group, —(OCH₂CH₂)ₘ—, —(OCH₂CH₂CH₂)ₘ—, or —[OCH₂CH(CH₃)]ₘ—, wherein m and n are each independently 0 to 500;
X is hydrogen, halogen, —N₃, —CN, —OH, —OSO₃⁻, —OR, —SH, —SR, —S—S—R, —SO₃H, —SO₃R, —SO₃⁻, —PO₃H₂, —PO₃H⁻, —(PO₃)²⁻, —P(═O)(—OR′)(OR″), —OPO₃H₂, —OPO₃H⁻, —O(PO₃)²⁻, —COOH, —COO⁻, —COOR, —CONR′R″, —NH₂, —NR′R″, —N(COR′)R″, —N⁺R′R″R′″, —N⁺C₅H₅, —(OCH₂CH₂)ₘ—OR, —(OCH₂CH₂CH₂)ₘ—OR, —[OCH₂CH(CH₃)]ₘ—OR, a polyol, or a monosaccharide or polyethylene oxide derivative thereof;
R is R₁, R₁(CH₂)ₙR₂ or —(CH₂)ₙR₂X; and,
R′, R″, R′″ are each independently hydrogen, alkyl, cycloalkyl, alkyl or cycloalkyl substituted by one or more hydroxyl groups, alkyl or cycloalkyl substituted by one or more carboxylic groups, —(CH₂CH₂O)ₙR, —(CH₂CH₂CH₂O)ₙR, or —[CH₂CH(CH₃)O]ₙR.

6. The method according to claim 1 wherein said alkyl protective moiety comprises a compound of formula (II), formula (III), or both: 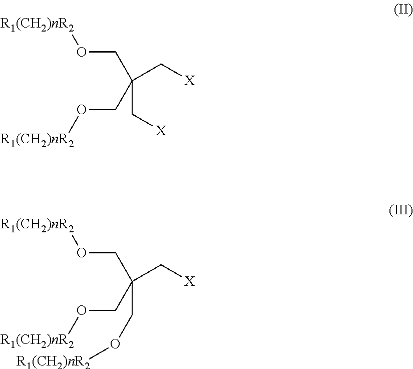
wherein
R₁ is hydrogen, or a C₁₋₅₀ straight or branched alkyl or alkenyl, optionally substituted with one or more halogen atoms;
R₂ represents a single bond, an aromatic or alicyclic group, —(OCH₂CH₂)ₘ—, —(OCH₂CH₂CH₂)ₘ—, or —[OCH₂CH(CH₃)]ₘ—;
m and n are each independently 0 to 500;
X is hydrogen, halogen, —N₃, —CN, —OH, —OSO₃⁻, —OR, —SH, —SR, —S—S—R, —SO₃H, —SO₃R, —SO₃⁻, —PO₃H₂, —PO₃H⁻, —(PO₃)²⁻, —P(═O)(—OR′)(OR″), —OPO₃H₂, —OPO₃H⁻, —O(PO₃)²⁻, —COOH, —COO⁻, —COOR, —CONR′R″, —NH₂, —NR′R″, —N(COR′)R″, —N⁺R′R″R′″, —N⁺C₅H₅, —(OCH₂CH₂)ₘ—OR, —(OCH₂CH₂CH₂)ₘ—OR, —[OCH₂CH(CH₃)]ₘ—OR, a polyol, or a monosaccharide or polyethylene oxide derivative thereof;
R is R₁, R₁(CH₂)ₙR₂ or —(CH₂)ₙR₂X; and,
R′, R″, R′″ are each independently hydrogen, alkyl, cycloalkyl, alkyl or cycloalkyl substituted by one or more hydroxyl groups, alkyl or cycloalkyl substituted by one or more carboxylic groups, —(CH₂CH₂O)ₙR, —(CH₂CH₂CH₂O)ₙR, or —[CH₂CH(CH₃)O]ₙR.

7. The method according to claim 1 wherein said alkyl protective moiety is a homo- or copolymer of the formula (IV): 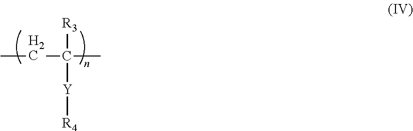
wherein
R₃ and R₄ are each independently hydrogen, halogen, cyano, a maleic anhydride group, phenyl, or a C₁₋₅₀ straight or branched alkyl optionally substituted with one or more halogen atoms;
Y represents a single bond, —O—, —CO—, —CO—O—, —O—CO—, —CONR′—, —O—CO—NR′—, or —NR′—CO—, wherein R′ represents hydrogen or alkyl, and n is 10 to 500.

8. The method according to claim 1 wherein said alkyl protective moiety is a polymer of the formula (V): 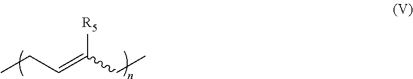
wherein
R₅ is hydrogen, halogen, or a C₁₋₅₀ straight or branched alkyl optionally substituted with one or more halogen atoms, and
n is 10 to 500.

9. The method according to claim 1 wherein said alkyl protective moiety is a polymer of the formula (VI): 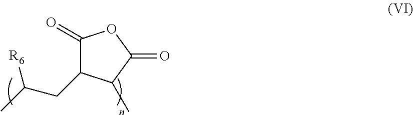
wherein
R₆ is a C₁₋₅₀ straight or branched alkyl optionally substituted with one or more halogen atoms, and
n is 10 to 500.

10. (canceled)

11. The method according to claim 1 wherein the alkyl protective moiety comprises a polyoxyethylene alkyl ether having the formula (VII):
R—(OCH₂CH₂)ₙ—OR₁ (VII)
wherein
R is an optionally substituted, linear or branched, saturated, carbo- or heteroalkyl chain bearing 4 to 18 carbon atoms,
n is 1 to 30, and
R₁ is hydrogen, R, —SO₃⁻, or —PO₃²⁻.

12-18. (canceled)

19. An electrode comprising nanostructures on a substrate, wherein said nanostructures comprise carbon and metal catalyst and have been protected in accordance with the method of claim 1.

20. Nanostructures comprising carbon and metal catalyst that have been protected in accordance with the method of claim 1.

21. A method for detecting electrochemical species in a fluid:
applying a voltage between a working electrode and a reference electrode to produce a current between said working electrode and an auxiliary electrode,
wherein said working electrode comprises nanostructures on a substrate,
wherein said nanostructures comprise carbon, metal catalyst, and an alkyl protective moiety that forms an alkyl protective moiety layer disposed directly adjacent to at least a portion of said carbon, said metal catalyst, or both,
and wherein said current is proportional to the concentration of said electrochemical species in said fluid.

22. The method according to claim 21 where said electrochemical species comprises free chlorine or total chlorine.

23. A method for detecting electrochemical species in a fluid comprising:
applying a voltage between a working electrode and a reference electrode to produce a current between said working electrode and a reference electrode,
wherein said working electrode comprises nanostructures on a substrate,
wherein said nanostructures comprise carbon, metal catalyst, and an alkyl protective moiety that forms an alkyl protective moiety layer disposed directly adjacent to at least a portion of said carbon, said metal catalyst, or both, and
wherein said current is proportional to the concentration of said electrochemical species in said fluid.

24-39. (canceled)

40. An electrode comprising a conductive structure on a substrate, wherein the conductive structure comprises a conductive layer and an alkyl protective moiety disposed directly adjacent to at least a portion of the conductive layer, wherein said conductive structure is characterized as having one or more of decreased surface hydrophobicity, decreased background non-faradaic current, decreased nonspecific adsorption of electrochemical species, relative to said conductive layer.

41. The electrode according to claim 40 wherein said conductive layer comprises diamond, graphite, or carbon nanostructures.

42. The electrode according to claim 41 wherein said conductive layer comprises graphite comprising 2D-3D graphene structures, screen printing carbon nanotube paste, or a combination thereof.

43-45. (canceled)
